(19) United States
(12) Patent Application Publication
(10) Pub. No.: US 2018/0129874 A1
(43) Pub. Date: May 10, 2018

(54) AUGMENTED REALITY SYSTEM AND METHOD

(71) Applicant: METAVERSE PTY LTD, North Melboume, Victoria (AU)

(72) Inventors: Thea-Mai Baumann, North Melbourne (AU); Kati Elizabeth, Footscray (AU); Maya Kerr, South Melbourne (AU)

(21) Appl. No.: 15/575,534

(22) PCT Filed: May 19, 2016
(86) PCT No.: PCT/AU2016/050376

§ 371 Date: Nov. 20, 2017

(30) Foreign Application Priority Data
May 20, 2015 (AU) 2015901829

(51) Int. Cl. G06K 9/00; G06F 3/0481

(52) U.S. Cl. CPC G06K 9/00355; G06K 9/00671; G06F 3/0416; G06K 9/00288; G06F 3/04815

(57) ABSTRACT

A system for providing augmented reality, the system including a client device having an imaging device that in use images a pattern associated with at least part of an object, a display and at least one electronic processing device that identifies the pattern using signals from the imaging device, identifies a visualisation associated with the pattern using a user profile defining visualisations associated with respective patterns and causes the display to display the object as imaged by the imaging device and the visualisation provided in conjunction with the object.

### BACKGROUND OF THE INVENTION

The present invention relates to a system and method for providing augmented reality, and in one particular to a customisable augmented reality system using patterns provided on objects. The present invention also relates to a testing system for testing production of an augmented reality object as well as packaging for display of an augmented reality object.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

The use of augmented reality to enable visualisations to be presented on a display in conjunction with images of an object is known. For example, US 2011/0310260 describes an augmented reality application in which an emblem located on an object is detected. After the emblem is detected an augmented reality object may be displayed on a display.

Typically however uptake of augmented reality applications has been limited, primarily due to limited appeal of the technology both in terms of the appearance of the emblems that are detected and also the visualisations that are presented. Additionally, most augmented reality systems suffer from a lack of user interaction, meaning such system rapidly lose appeal.

### SUMMARY OF THE PRESENT INVENTION

In one broad form the present invention seeks to provide a system for providing augmented reality, the system including a client device having:
a) an imaging device that in use images a pattern associated with at least part of an object;
b) a display; and,
c) at least one electronic processing device that:
   i) identifies the pattern using signals from the imaging device;
   ii) identifies a visualisation associated with the pattern using a user profile defining visualisations associated with respective patterns; and,
   iii) causes the display to display:
      (1) the object as imaged by the imaging device; and,
      (2) the visualisation provided in conjunction with the object.

In one broad form the present invention seeks to provide a system for providing augmented reality, the system including a client device having:
a) an imaging device that in use images a pattern associated with at least part of an object;
b) a display; and,
c) at least one electronic processing device that:
   i) identifies the pattern using signals from the imaging device;
   ii) identifies content associated with the pattern using a user profile defining visualisations associated with respective patterns;
   iii) causes the display to display the object as imaged by the imaging device; and,
   iv) causes the client device to present the content.

Typically a visualisation is defined by visualisation data defining a combination of one or more visualisation elements.

Typically a visualisation is defined by a user, and wherein the at least one processing device:
a) displays a representation of a number of visualisation elements; and,
b) determines selection of at least one visualisation element in accordance with user input commands, the selected visualisation elements being used to define the visualisation data.

Typically a user defines a combination of a plurality of visualisation elements.

Typically the at least one processing device:

a) displays a representation of the visualisation defined by the user; and,

b) modifies the visualisation in accordance with user input commands.

Typically the at least one processing device:
a) receives an indication of available visualisation elements from at least one of:
   i) a remote server; and,
   ii) a client device associated with another user; and,
b) displays the representation of a number of visualisation elements in response to the received indication.

Typically the at least one processing device:
a) displays the representation of a number of visualisation elements using visualisation data indicative of a first visualisation; and,
b) uses selection of at least one visualisation element to generate a second visualisation.

Typically the visualisation elements include at least one of:

a) a visualisation position relative to the pattern;

b) multimedia content;

c) a visualisation object;

d) a hologram;

e) an animation of a visualisation object; and,

f) visualisation text.

Typically the at least one processing device:
a) determines an identity of another user; and,
b) provides visualisation data to the other user, thereby allowing a user to share or gift a visualisation to the other user, by at least one of:
   i) transferring the visualisation data to a client device of the other user; and,
   ii) storing the visualisation data as part of a user profile associated with the other user.

Typically visualisation data for a number of visualisations is hosted by a remote server and wherein the at least one processing device retrieves the visualisation data from the remote server via a communications network.

Typically user profiles for a number of users are hosted by a remote server.

Typically the at least one processing device:
a) determines a pattern identifier associated with the pattern;
b) provides the pattern identifier to the remote server via a communications network, the remote server being responsive to:
   i) identify the visualisation associated with the pattern using the pattern identifier and the user profile; and,
   ii) provide an indication of the visualisation to the at least one processing device; and,
c) receives the indication of the visualisation from the remote server.

Typically the at least one processing device:
a) provides pattern data indicative of the pattern to the remote server, the remote server being responsive to:
   i) determine a pattern identifier associated with the pattern;
   ii) identify the visualisation associated with the pattern using the pattern identifier and the user profile; and,
   iii) provide an indication of the visualisation to the at least one processing device; and,
b) receives the indication of the visualisation from the remote server.

Typically pattern identifier is determined by at least one of:
a) performing matching of the pattern to one of a number of reference patterns using pattern matching; and,
b) decoding a pattern identifier encoded within the pattern using a decoding algorithm.

Typically the object is an item of apparel, and wherein the at least one processing device:
a) determines a wearer identity associated with a wearer of the respective object; and,
b) selects one of a number of user profiles using the wearer identity.

Typically the wearer identity is determined using at least one of:

a) one or more patterns associated with objects worn by the user;

b) facial recognition techniques; and,

c) user input commands.

Typically the system:

a) determines an action associated with a detected pattern; and,

b) causes the at least one action to be performed.

Typically the system:

a) determines user interaction with the visualisation; and,

b) causes at least one action to be performed in response to the user interaction.

Typically the object is at least one of:

a) attachable fingernails;

b) toys;

c) packaging; and,

d) clothing.

In one broad form the present invention seeks to provide a method for providing augmented reality, the method including:
a) using an imaging device to image a pattern associated with at least part of an object; and,
b) in at least one electronic processing device:
   i) identifying the pattern using signals from the imaging device;
   ii) identifying a visualisation associated with the pattern using a user profile defining visualisations associated with respective patterns; and,
   iii) causing a display to display:
      (1) the object as imaged by the imaging device; and,
      (2) the visualisation provided in conjunction with the object.

In one broad form the present invention seeks to provide a method for providing augmented reality, the method including:
a) using an imaging device to image a pattern associated with at least part of an object; and
b) in at least one electronic processing device:
   i) identifying the pattern using signals from the imaging device;
   ii) identifying content associated with the pattern using a user profile defining visualisations associated with respective patterns;
   iii) causing the display to display the object as imaged by the imaging device; and,
   iv) causing a client device to present the content.

In one broad form the present invention seeks to provide a testing system for testing production of an augmented reality object, the objects having a pattern associated with at least part of an object, the system including:

a) a housing;

b) a stand that supports a plurality of objects within the housing;

c) an illumination source for illuminating the plurality of objects; and,

d) a mounting that in use receives a client device, wherein the client device includes:
i) an imaging device that in use images a pattern associated with at least part of an object; and,
ii) at least one electronic processing device that:
   (1) identifies the pattern using signals from the imaging device;
   (2) determines an identifier associated with the pattern; and,
   (3) validates the identifier.

Typically the mounting includes bosses that position an imaging device of the client device in a defined position relative to the housing.

Typically the mounting is removably replaceable, a respective mounting being provided for each of a number of different client devices.

Typically the stand is provided proud of a stand surface, the stand surface having a mid-tone contrast.

Typically the stand surface is at least one of:

a) middle grey; and,

b) pantone 425U.

Typically the illumination source includes a plurality of LEDs configured to provide about 800 lux illumination.

In one broad form the present invention seeks to provide packaging for an augmented reality object, the object including a nail having a pattern provided on a surface thereof, the packaging including:
a) a housing including a window; and,
b) a mounting including at least one opening that supports a nail therein, the mounting being positioned within the housing so that a patterned surface of the nail is aligned with the window, thereby allowing the pattern to be imaged by an imaging device whilst the nail is within the packaging.

Typically the housing includes a plurality of windows spaced around an outer perimeter edge surface, and wherein the mounting includes an edge surface mounting including a plurality of openings, each opening being aligned with a respective window.

Typically the housing includes a window positioned in a front surface, and wherein the mounting includes a front surface mounting including a single opening aligned with the front surface window.

Typically the housing includes a lid removably mounted to a body.

Typically the lid defines a front surface.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

An example of the present invention will now be described with reference to the accompanying drawings, in which:—

FIG. 1A is a flowchart of an example of a method for providing augmented reality;

FIG. 1B is an image of an example of an object including a pattern;

FIG. 2 is a schematic diagram of an example of a network architecture;

FIG. 3 is a schematic diagram of an example of a processing system;

FIG. 4 is a schematic diagram of an example of a client device;

FIGS. 5A and 5B are a flowchart of an example of a process for displaying a visualisation;

FIG. 6A is a schematic diagram of an example of a client device showing an augmented reality visualisation;

FIG. 6B is a schematic diagram of an example of a visualisation marketplace;

FIGS. 7A to 7C are a flowchart of an example of a method of creating a visualisation;

FIG. 8A is a schematic diagram of an example of a user interface used in creating a visualisation;

FIGS. 8B to 8D are schematic diagrams of examples of a visualisation being created;

FIG. 9 is a flowchart of an example of a method of gifting a visualisation;

FIG. 10 is a flowchart of an example of a method of selling a visualisation;

FIG. 11A is a flowchart of an example of a method of publishing an image including visualisations;

FIG. 11B is a flowchart of an example of a method of creating a visualisation including an image;

FIGS. 11C to 11F are schematic diagrams of an example of client devices showing a visualisation including an image;

FIG. 12 is a flowchart of an example of a method of displaying visualisations associated with a third party object;

FIG. 13 is a flowchart of an example of a method of displaying visualisations associated with a third party object;

FIG. 14 is a schematic diagram of an example of client devices showing augmented reality visualisations;

FIG. 15 is a flowchart of an example of a method of publishing an image including visualisations;

FIG. 16A is a schematic plan view of an example of a testing system for testing objects with patterns applied thereto;

FIG. 16B is a schematic perspective plan view of the testing system of FIG. 16A;

FIG. 16C is a schematic first end view of the apparatus of FIG. 16A;

FIG. 16D is a schematic first side view of the apparatus of FIG. 16A;

FIG. 16E is a schematic second end view of the apparatus of FIG. 16A;

FIG. 16F is a schematic second side view of the apparatus of FIG. 16A;

FIG. 17A is a schematic plan view of an example of display packaging for a single false nail;

FIG. 17B is a schematic side view of the display packaging of FIG. 17A;

FIG. 17C is a schematic plan view of the mounting of FIG. 17A;

FIG. 17D is a schematic side view of the mounting of FIG. 17A;

FIG. 18A is a schematic perspective view of an example of display packaging for multiple false nails;

FIG. 18B is a schematic exploded perspective side view of the display packaging of FIG. 18A; and,

FIG. 19 is a schematic perspective view of an example of a display arrangement including display packaging.

### DETAILED DESCRIPTION OF THE PREFERRED EMBODIMENTS

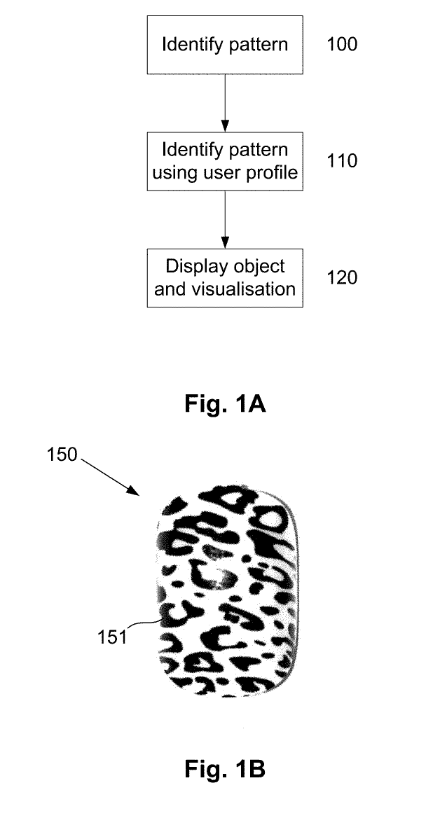

An example of a method for providing augmented reality will now be described with reference to FIG. 1A.

For the purpose of this example, it is assumed that the method is performed utilising a client device having an imaging device, a display and at least one processing device.

The nature of the client device may vary depending upon the preferred implementation and could include a suitably programmed computer system, or the like. In one particular example, the client device includes a portable device such as a mobile phone, tablet, or the like or a wearable device, such as a smart watch, augmented reality glasses or a headset or head mounted displays, such as Google Glass™, Hololens™, or the like. Additionally this could encompass virtual reality systems, such as headsets, that are additionally adapted to sense and display an image of real situations, as well as other wearable sensing systems. Whilst reference is made to a single device, it will be appreciated that the client device could include multiple interfaced devices, such as a mobile phone in communication with a wearable display and camera, and reference to a device is not intended to be limiting.

In use, the imaging device images a pattern associated with at least part of an object. The object can be of any suitable form but in one particular example includes an item of apparel that can be worn by a user. The item of apparel could include clothing, or accessories, such as jewellery, or the like. In one particular example, the objects are false nails, such as acrylic nails, that can be attached to finger or toenails of a wearer. However this is not essential and any suitable form of object could be used, such as any wearable fashion patterns, garments, fabrics, printed surfaces or the like. Similarly the patterns could be provided on other objects, including but not limited to toys, games, packaging, novelty items, or the like.

The nature of the pattern will vary depending upon the preferred implementation. Typically the pattern is a styled pattern designed to be aesthetically appealing. In one example, the pattern includes a number of individual graphical elements that together encode information, such as a pattern identifier, in accordance with an encoding algorithm, thereby allowing the encoding algorithm to be used to reconstruct the pattern identifier from an image of the pattern. An example of such a pattern is shown in FIG. 1B, which shows a false nail 150, including a number of pattern features 151, the shape, position and number of which can be used to encode the pattern identifier. However, this is not essential and patterns could be of any suitable form, such as a picture, logo, image or the like, in which case these could be identified using pattern matching techniques or the like, as will be described in more detail below.

In operation, a user uses the client device to image the object including the pattern. The processing device then operates to identify the pattern using signals from the imaging device at step 100. This process will typically involve performing image processing, such as image enhancement, contrast/brightness adjustment, edge detection or the like, allowing the pattern to be isolated within the image. It will also be appreciated that any captured image may include multiple objects, and hence patterns, in which case the process may involve isolating the different patterns, allowing each of these to be processed individually.

At step 110, the processing device identifies a visualisation associated with the pattern using a user profile defining visualisations associated with respective patterns. Thus, each user of the system will typically have an associated user profile that defines associations between patterns and respective visualisations, thereby allowing users to choose the visualisations that are associated with their objects.

In this regard, it is typical for a limited number of patterns to be available and accordingly the same pattern will typically be repeated on multiple objects. If a single visualisation were associated with each unique pattern, this would result in limited ability to display visualisations, in particular limiting the number of visualisations to the number of available patterns. Additionally, there would be no opportunity for personalisation, making the arrangement of limited appeal. Accordingly, the system utilises a user profile for each user to allow the user to associate particular visualisations with their respective patterns, so that their own combination of visualisations can be defined.

The nature of the visualisations can vary depending on the preferred implementation. In one example, the visualisations are in the form of images forming hologramatic representations of three dimensional objects, so that the appearance of the visualisation alters depending on the orientation from which the pattern is viewed. In one example, the visualisations are fashion related or themed, for example representing jewellery or the like. However, this is not essential, and the visualisations could be of any appropriate form. In one example the visualisations include multimedia, such as images, including photos, social media profile pictures, video or audio information, or the like. The visualisations could be in the form of virtual goods. The visualisations could include text, for example to display textual messages, contact information, social media usernames, encrypted messages, or the like. The visualisations could include emoji, a social media status or the like, and could be themed, for example relating to gaming characters, celebrities, or the like. The visualisations could also be interactive, for example represent a gaming character, avatar, or part of a game with which the users can interact. In one example, the visualisation could be of a virtual pet, which the user can interact with and care for. The visualisations can also develop over time, allowing users to add to, enhance or expand visualisations through interaction, acquisition or the like. For example, for gamers features for an avatar can be adopted—offline—when viewed through a suitable application.

It will be appreciated that the term visualisations is not intended to be limiting and could include any form of content that is associated with the object.

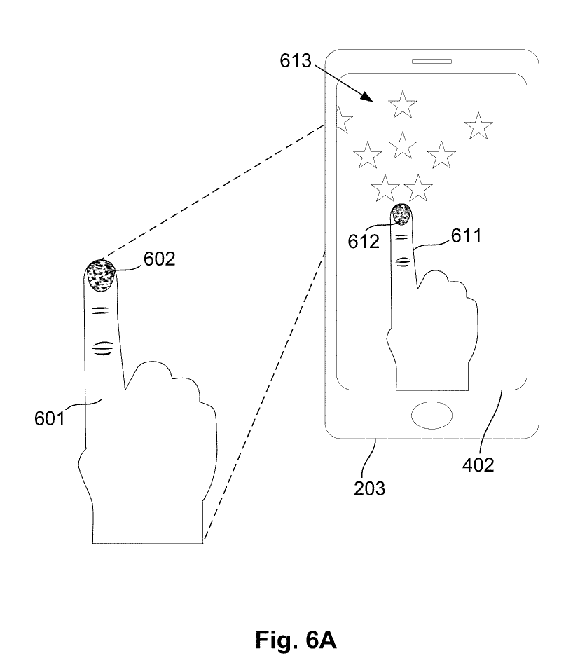

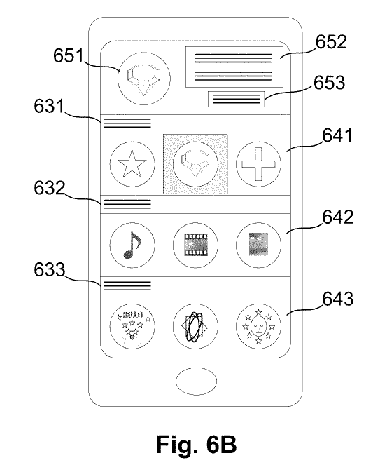

At step 120 the display then displays the object, as imaged by the imaging device, with the visualisation being presented in conjunction with, and typically in a defined location relative to the object. Thus, in the event that the object is a false nail attached to the fingernail of the user, the display will typically display at least part of the user's hand together with an overlaid visualisation, an example of which is shown in FIG. 6, and which will be described in more detail below.

In any event, it will be apparent that the above described system provides an augmented reality system that allows visualisations to be displayed associated with objects having patterns provided thereon. In addition to allowing the visualisations to be displayed, user profiles are used to allow users to define the visualisations that are associated with each pattern, thereby allowing the user to have a unique appearance of visualisations.

This unique appearance can be displayed when viewed through a client device configured with the respective user profile. By default, a user's own client device would be in an appropriate manner, providing a mechanism for users to individualise their own appearance, without this necessarily being outwardly apparent either to other people, or other users of the augmented reality system. This is enhanced by the fact that the patterns are visually aesthetic, meaning they outwardly appear to be part of normal fashion accessories. This is important in many environments, for example where appearance requirements are defined, such as in workplaces or schools, where users are required to conform to particular dress codes or standards, but nevertheless may wish to have an individualised appearance whilst still meeting appearance guidelines. For example, in a school environment this allows students to create visualisations associated with objects they wear, without appearing outwardly to breach dress code standards.

Furthermore, by virtue of the personal nature of the user profile, the individual's virtual appearance as embodied in the visualisations, cannot be easily viewed by other user's of the system, meaning the user could choose any visualisations without these necessarily being viewable by other users. However, as will be described in more detail below, the system allows visualisations and/or the user profiles to be shared, allowing a user to share their appearance with other selected users, such as friends or the like.

The user profile also allows a record of viewed patterns to be stored, which can in turn can be used to earn rewards or unlock additional features, allow for interaction with gaming, trading and exchanging of visualisations and a number of other features, as will be described in more detail below.

A number of further features will now be described.

In one example, each visualisation is defined by visualisation data defining a combination of one or more visualisation elements. The use of individual visualisation elements provides a simple mechanism for allowing users to combine visualisation elements in different ways in order to create different visualisations. Thus, each visualisation element can act as a building block allowing complex visualisations to be built up through a suitable combination.

The visualisation elements can be of any suitable form and may include visualisation objects, such as graphical representations of items, holograms, multimedia content, animations, text or the like. The visualisation elements could also include properties of the visualisations such as a visualisation position, corresponding to the position the visualisation should be presented relative to the scanned pattern, animations of visualisation objects, interactive features, such as responses to input commands, or the like. In practice, any feature which can be presented by a client device could form by a visualisation element and the system is not wholly limited to graphical representation alone. For example, audio files could be associated with a visualisation in which case when the visualisation is presented, audio information is also presented. In one preferred example, the visualisation elements include graphical representations of fashion related “bling” objects, such as jewels, or the like, as will be described in more detail below. Particular examples of visualisation elements include images of the user and/or other users, avatars, game characters, skins, licensed content, emoji, messages, virtual pets, logos, product information, Pokémon™, videos, or the like.

To allow visualisations to be constructed, the processing device is typically adapted to display a representation of a number of visualisation elements and then determine selection of one or more of these elements in accordance with user-input commands, with selected visualisation elements being used to define visualisation data. As part of this process, the processing device can display a representation of the visualisation as this is defined by the user, modifying the representation in accordance with user input commands as visualisation elements are added, moved or altered.

The visualisations elements can be obtained in any one of a number of ways. For example, available visualisation elements could be obtained from a remote processing system, such as a remote server, which hosts a virtual shop or other forum from which visualisation elements can be acquired. This allows users to purchase visualisation elements or complete visualisations, as well as providing a mechanism for visualisation elements to be created, sold, exchanged, traded, or the like.

Additionally and/or alternatively, visualisation elements could also be received from other users, for example as part of a visualisation gifted or shared by, or traded with another user. Visualisation elements could also be imported from other software applications, such as a graphical design package, camera, photo editing software, or the like, allowing users to create their own visualisation elements. Additionally and/or alternatively, these could be imported from other virtual reality applications, such as Second Life™, World of Warcraft™, or the like, as well as social media applications, such as IMVU™, Snapchat™ or the like.

Visualisation elements can be provided individually, or could be extracted from existing visualisations, allowing elements from one or more first visualisations to be combined to form a second visualisation. In this case, the processing device displays a representation of a number of visualisation elements using visualisation data indicative of one or more first visualisations and then uses a selection of one of the visualisation elements to generate a second visualisation.

In one example the processing device is adapted to determine an identity of another user and provide visualisation data to the other user, either by transferring the visualisation data to a client device of the other user or by storing the visualisation data as part of a user profile of the other user. This provides a mechanism to allow a user to gift, share, trade or exchange a visualisation with another user.

In one example, visualisation data for a number of visualisations is hosted by a remote server and wherein the at least one processing device retrieves the visualisation data from the remote server via a communications network. This can either be performed each time a visualisation is to be displayed, although more typically this is performed a single time, with the visualisation data being cached locally on the client device, thereby reducing the need to access the remote server.

User profiles for a number of users can be hosted by the remote server. This allows user profiles for a number of different users to be hosted centrally, which can facilitate exchange of visualisations, for example allowing a user to access their own visualisations using a number of different client devices. This can also be used to facilitate control over the visualisations, for example the remote server to update profiles to add or remove gifted visualisations, or the like. However, alternatively, the profile could be stored locally on the client device, and optionally synchronised with a remote server as required. For example, a subset of information within the user profile, such as currently assigned visualisations, could be stored locally on the client device, with additional information, such as unassigned visualisations, history of interactions or the like being stored remotely, and accessed as required.

When the user profiles are stored centrally, the client device will be adapted to determine the visualisation that should be displayed from the remote server. For example, the processing device can determine a pattern identifier associated with a scanned pattern and provide the pattern identifier to the remote server via a communications network. The server is responsive to identify the visualisation associated with the pattern using a pattern identifier and the user profile and provide an indication of the visualisation to the processing device, allowing this to be displayed. Thus, in this case, the remote server is responsible for identifying the visualisation that should be displayed based on an identifier determined by the client device. Alternatively however pattern data itself can be transferred to the remote server, allowing the remote server to determine the identifier and hence the visualisation that should be displayed.

Identification of the pattern could be achieved by decoding the pattern itself into data using a predetermined algorithm however, this is not necessarily essential and alternatively pattern matching to one of a number of predetermined reference patterns could be performed. This latter approach is generally more computationally expensive as every scanned pattern then needs to be compared to reference patterns in order to allow this to be decoded. However, this does allow for greater flexibility in terms of patterns that could be used within the system in particular not limiting these to those in which an identifier is mathematically encoded.

One benefit of centrally stored profiles is that it allows a user to gain access to another user's profile, thereby allowing them to view the visualisations the other user has defined. For example, the processing device can determine a wearer identity associated with a wearer of an object, and then select one of a number of user profiles using the wearer identity. Thus, in normal operation, a client device is associated with a respective user and when a pattern is scanned will then simply retrieve the visualisation defined by that respective user, from the respective user's user profile. However this is not essential and alternatively, an identity of a wearer could be determined so that a user can use their own client device to scan objects worn by the wearer and view the visualisations the wearer has defined.

In this example, a wearer identity can be determined in any one of a number of manners. For example this could be achieved by using user input commands. Thus, when scanning objects worn by a friend, a user could select the friend's identity from a list of friends listed in their client device, with this information then being used to access the friend's user profile and hence display the friend's visualisations. However alternatively the identity could be determined using facial recognition techniques, or by detecting one or more patterns associated with objects worn by the user. Thus, each user could have a unique pattern which could be used to identify them. Alternatively, users may wear a unique combination of patterns that define a signature which can be used to distinguish that particular user from other users.

In one example, the detection of a pattern can also be used for other purposes, for example to act as a control input. In this case, the system can operate to determine an action associated with a detected pattern and cause the at least one action to be performed. This can be used in a wide range of ways, for example to trigger interactions with the client device. Thus, a user can scan a particular object pattern, causing a defined action to be performed, such as deactivating an alarm, opening a message or application, or the like. This could also be used in gaming environments, for example to act as control inputs for game. In one example, such actions can be defined in the user profile in addition to or as an alternative to displaying a visualisation.

In one example, the displaying of a visualisation could trigger additional actions, such as providing access to additional content, such as multimedia content. For example, objects could be associated with a respective item of content, in which case when the object is scanned using a client device, the content can be downloaded to the client device. For example, the object could be associated with a video, animation or song, in which case when the object is scanned, the respective video, animation or song is downloaded to the client device 203 and presented to the user.

In one example, the respective content is associated with the object when the object is created, allowing users to purchase the content by purchasing the physical object. For example, the object could be promotional article associated with an artist, such as popstar or band, in which case the content could be content created by or on behalf of the artist, such as a song, video, fan message or animation of the artist. As a further alternative, however, users could elect to purchase the content, and then associate this with an existing object, as will be described in more detail below.

The system can also be adapted to allow individuals to interact with visualisations. In this regard, when a visualisation is displayed on the display, the client device can be adapted to detect user inputs, such as touching a particular part of the display, and then perform associated actions. The actions could include modifying the visualisation, for example by adding an additional visualisation element, effect or animation, but could also include other actions, such as triggering sharing or gifting of the visualisation.

In a further example, the visualisation could represent a user interface, such as a gaming interface, messaging interface, social network interface, web-browser or the like, and could display one or more controls allowing the user to interact with the visualisation. For example, the visualisation could represent a virtual pet, with the user interacting with the visualisation to care for the pet, functioning in a manner similar to a Tamagotchi, or the like. It will be appreciated that in this example, the user profile can be adapted to store information regarding the user's interactions with visualisations, thereby allowing a status of the virtual pet, or other gaming interaction to be maintained.

The user profiles can also be adapted to store other additional information, including a history of patterns scanned by the user, visualisations displayed or the like. In this regard, this can facilitate enhanced interaction with the system. For example, the scanning of patterns and/or viewing of visualisations can be treated in a manner similar to collection of collectable items, with the user being rewarded for meeting certain milestones. For example, in the event that the user scans a specific combination of patterns, this can be used to access a reward, such as credit for spending on acquiring new visualisations, access to random and/or rare visualisations, or real-life rewards, such as vouchers, store credit, or the like.

In one example, a user is encouraged to scan each of a number of defined patterns, with rewards being unlocked upon completion of the task. This encourages the users to further interact with the system, thereby enhancing user appeal. Furthermore, by making some patterns particularly rare, this can be used to increase the difficulty associated with completing the task. However, rewards could be gained in other manners, such as by interacting with visualisations or the like.

Whilst the above described arrangements have focussed on the scanning of individual patterns, it will be appreciated that multiple patterns could be scanned simultaneously, with the visualisations presented being a combination of the visualisations associated with each pattern.

It will be appreciated that in the above described arrangements, detection of the patterns is important to ensure that the display of visualisations is successfully performed. In the current system, as patterns are intended to have a visually aesthetic appearance, these are not necessarily the most robust from a detection and interpretation perspective. Accordingly, it is important that the patterns are suitably provided on the objects, for example through printing, attachment, positioning or the like.

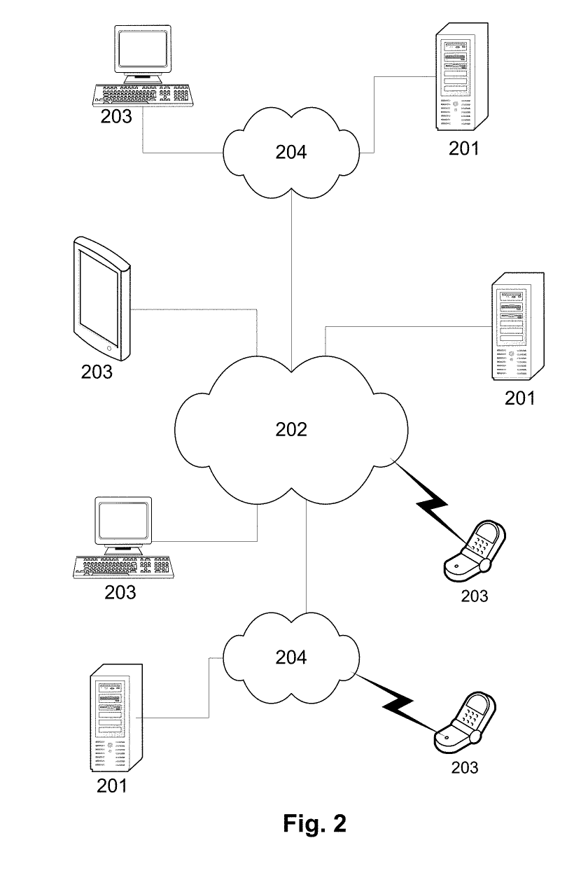

In one example, the above process is performed by one or more processing systems operating as part of a distributed architecture, an example of which will now be described with reference to FIG. 2.

In this example, a number of base stations 201 are coupled via communications networks, such as the Internet 202, and/or a number of local area networks (LANs) 204, to a number of client devices 203. It will be appreciated that the configuration of the networks 202, 204 are for the purpose of example only, and in practice the base stations 201 and client devices 203 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

In one example, each base station 201 includes one or more processing systems 210, each of which may be coupled to one or more databases 211. The base station 201 is adapted to be used in hosting profiles and/or visualisations. The client devices 203 are typically adapted to communicate with the base station 201, allowing visualisations to be displayed.

Whilst the base station 201 is a shown as a single entity, it will be appreciated that the base station 201 can be distributed over a number of geographically separate locations, for example by using processing systems 210 and/or databases 211 that are provided as part of a cloud based environment. However, the above described arrangement is not essential and other suitable configurations could be used.

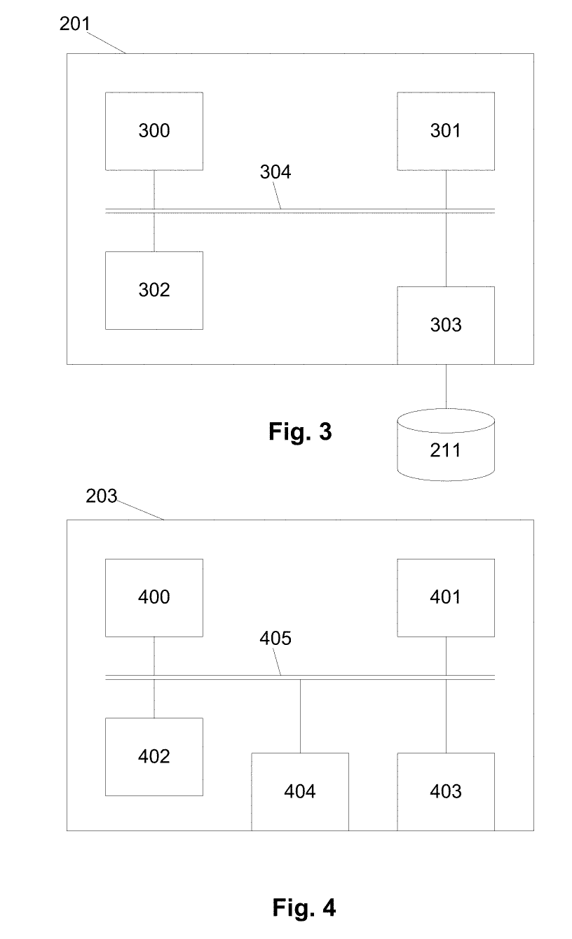

An example of a suitable processing system 210 is shown in FIG. 3. In this example, the processing system 210 includes at least one microprocessor 300, a memory 301, an optional input/output device 302, such as a keyboard and/or display, and an external interface 303, interconnected via a bus 304 as shown. In this example the external interface 303 can be utilised for connecting the processing system 210 to peripheral devices, such as the communications networks 202, 204, databases 211, other storage devices, or the like. Although a single external interface 303 is shown, this is for the purpose of example only, and in practice multiple interfaces using various methods (eg. Ethernet, serial, USB, wireless or the like) may be provided.

In use, the microprocessor 300 executes instructions in the form of applications software stored in the memory 301 to allow the required processes to be performed. The applications software may include one or more software modules, and may be executed in a suitable execution environment, such as an operating system environment, or the like.

Accordingly, it will be appreciated that the processing system 210 may be formed from any suitable processing system, such as a suitably programmed client device, PC, web server, network server, or the like. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

As shown in FIG. 4, in one example, the client device 203 includes at least one microprocessor 400, a memory 401, an input/output device 402, such as a keyboard and/or display, an external interface 403, and an imaging device 404, such as a camera or the like, interconnected via a bus 405 as shown. In this example the external interface 403 can be utilised for connecting the client device 203 to peripheral devices, such as the communications networks 202, 204, databases, other storage devices, or the like. Although a single external interface 403 is shown, this is for the purpose of example only, and in practice multiple interfaces using various methods (eg. Ethernet, serial, USB, wireless or the like) may be provided.

In use, the microprocessor 400 executes instructions in the form of applications software stored in the memory 401 to allow communication with the base station 201, for example to allow for imaging using the selection of parameter values and viewing of representations, or the like.

Accordingly, it will be appreciated that the client devices 203 may be formed from any suitable processing system, such as a suitably programmed PC, Internet terminal, lap-top, or hand-held PC. In one example the client device is a portable communications device such as a tablet, smart phone, or the like, or a wearable device, such as a smart watch, augmented reality glasses or headset, virtual reality headset, head mounted display, wearable screen, or the like. However, it will also be understood that the client devices 203 can be any electronic processing device such as a microprocessor, microchip processor, logic gate configuration, firmware optionally associated with implementing logic such as an FPGA (Field Programmable Gate Array), or any other electronic device, system or arrangement.

Examples of the processes for providing augmented reality will now be described in further detail. For the purpose of these examples it is assumed that one or more processing systems 210 host visualisations and user profiles, and which communicate with the client devices via hosted webpages or an App residing on the client device 203. The processing system 210 is therefore typically a server which communicates with the client device 203 via a communications network, or the like, depending on the particular network infrastructure available.

To achieve this the processing system 210 of the base station 201 typically executes applications software for hosting webpages and as well as performing other required tasks including storing, searching and processing of data, with actions performed by the processing system 210 being performed by the processor 300 in accordance with instructions stored as applications software in the memory 301 and/or input commands received from a user via the I/O device 302, or commands received from the client device 203.

It will also be assumed that the user interacts with the processing system 210 via a GUI (Graphical User Interface), or the like presented on the client device 203 using an App that displays data supplied by the processing system 210. Actions performed by the client device 203 are performed by the processor 400 in accordance with instructions stored as applications software in the memory 401 and/or input commands received from a user via the I/O device 402.

However, it will be appreciated that the above described configuration assumed for the purpose of the following examples is not essential, and numerous other configurations may be used. It will also be appreciated that the partitioning of functionality between the client devices 203, and the base station 201 may vary, depending on the particular implementation.

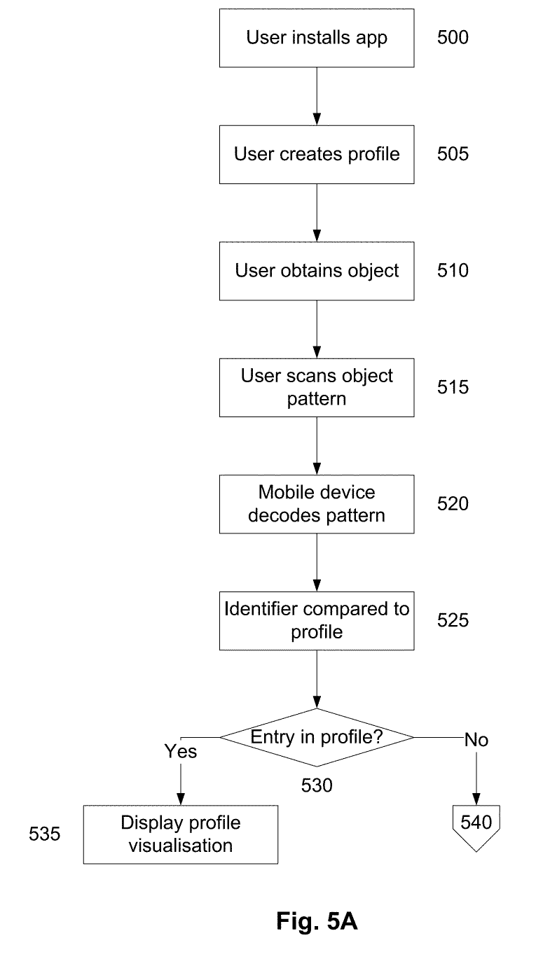

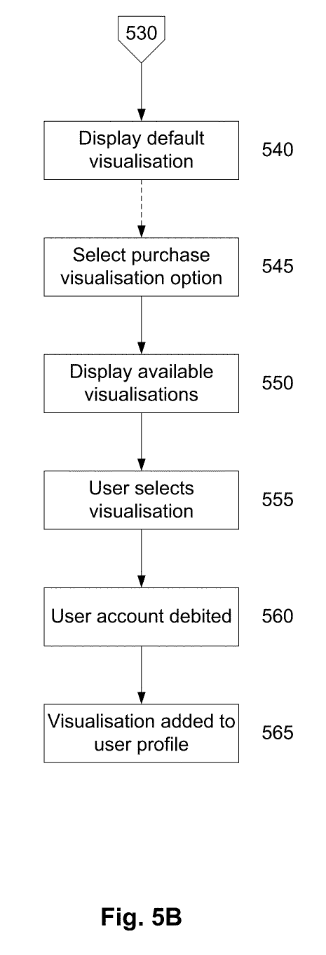

An example of a process for displaying a visualisation will now be described with reference to FIGS. 5A and 5B.

In this example, and assuming this is the first time the user has used the system, at step 500 the user installs the app. This process can be triggered manually, but in one example is performed by scanning a machine readable code, such as a QR code, barcode, or the like, which could be provided on packaging associated with an object, displayed as part of advertising, presented in a social media stream or the like. Scanning the code can causes the app to be downloaded and installed once relevant permissions have been provided. It will also be appreciated that the app could be downloaded from the app store in the normal manner.

After installing the app, the user can proceed with creating a user profile at step 505. The user profile is not necessarily required to view a basic default visualisation, but is required for additional interactions, and would therefore generally be created by default. The user profile can include a private component, only viewable by the user, but can also include a public component visible to other users, for example as part of a social network associated with the system.

To create the profile, the user is typically prompted by the app to provide relevant information, such as basic personal information and a username and password. This can also include providing additional optional information, such as defining user preferences, creating a public profile page, provide billing information, or the like. The profile could be linked to an existing social media account, allowing the user to login using another social media account. Once created, profile data indicative of the user profile is typically stored by the server 210 in a database 211, with some parts of the profile also being optionally stored on the client device 203. In any event, it will be appreciated that the creation of a profile can be achieved using traditional techniques and this will not therefore be described in further detail.

At step 510 the user obtains an object, for example by purchasing an object, viewing an object for sale or an object worn by another user, and then scans the pattern provided on the object at step 515. This process would typically involve opening the app and then positioning the object in front of the camera 404 of the client device 203, allowing the camera 404 to image the object. A sound or other indication is typically provided once the client device 203 has successfully focused on and imaged the object, as will be appreciated by persons skilled in the art.

At step 520, the client device 203 decodes the pattern and uses this to determine a pattern identifier using a decoding algorithm implemented within the app. The identifier is then compared to the user's profile at step 525 to determine whether the user has yet defined a visualisation to be associated with the corresponding pattern. This can either be performed locally, in the event that the profile is stored on the client device 203, or could be performed by accessing the server 210. At this stage, the client device 203 and/or server 210 could also update the user profile to record that the pattern has been scanned. This can be performed to maintain a scanning history for the user, which in turn can be used to unlock additional features, functionality, or rewards, for example if the user has completed a defined task, such as scanning a particular combination of patterns.

In any event, if it is determined that a visualisation is defined for a particular patter in the user profile at step 530, the respective visualisation is displayed at step 535, otherwise a default visualisation can be displayed at step 540.

In this regard, a default visualisation is taken to be one that is not user customised and hence would be displayed to any user scanning that respective pattern. The default visualisations could be defined within a default profile hosted by the server, and could be assigned to the pattern upon creation, for example by a provider of the pattern, or assigned by an operator of the system. Additionally and/or alternatively, the default visualisation could be randomly selected from one or more “stock” visualisations. This allows the system to display a visualisation, even in the event that one has not been defined or associated with the pattern by the user, allowing the user to interact with the system in a meaningful manner, whilst still allowing the user to create a custom visualisation at a later time, which could be an entirely new visualisations, or based on a modified version of the default visualisation.

The default visualisation could be themed to correspond to the pattern in some manner. For example, if the pattern is provided by a company, the default visualisation could include information regarding the company, such as a brand name, logo or the like. Alternatively, if the pattern relates to a game or film character, the visualisation could be an animated hologram of the character.

In one example, the default visualisation is fixed and cannot be altered, allowing suppliers of the pattern to have a degree of control over how this is used. However, this is not essential and the default visualisations could be dynamic and altered periodically, after a set number of views or the like. In a further example, the visualisation and hence the pattern might have a limited lifespan, which could be limited based on a time duration, for example corresponding to a respective fashion season, or the like. In this example, when the default profile is accessed, this can define whether the visualisation and/or pattern has expired, in which case no visualisation is displayed.

In either case the appearance is as shown generally in FIG. 6A. In this example, the client device 203 is used to image a finger 601 including a false nail 602 having a pattern provided thereon. The display 402 of the client device shows a representation 611 of the user's finger 601 as imaged by the client device camera 404, as well as the visualisation, which in this case is in the form of a series of stars 613 emanating from the false nail 612.

At this point, the user can also be provided with the option of creating purchasing or creating a visualisation. In the case of purchasing a visualisation, at step 545, the user selects a purchase visualisation option presented via the app on the client device 203. At step 550, the client device 203 displays visualisations available within a store hosted by the server 210. To achieve this, the client device 203 can present the user an interface allowing the user to search or browse available visualisations provided by the server 210.

In one example, this provides a marketplace allowing visualisation to be sold to users. In this regard, the visualisations could include hologrammatic representations, as well as other content, including but not limited to multimedia content, or the like. Additionally, the marketplace provides a mechanism to allow visualisation or other content to be sold, shared, gifted or the like, as will be described in more detail below.

An example of a marketplace interface is shown in FIG. 6B. In this example, the interface includes a number of title bars 631, 632, 633, and associated windows 641, 642, 643. Each title bar 631, 632, 633 represents a different category, in this example including visualisation elements 631, multimedia content 632, and visualisations 633, with the respective window including icons representing available visualisations or other content. The window is scrollable in a horizontal direction, allowing further icons within the category to be viewed, whilst the interface as a whole is scrollable vertically allowing further categories to be displayed. Users can select icons, with the respective visualisation, element or content being displayed in a viewing window 651, together with an associated textual explanation 652 and optional input 653, for example allowing a user to purchase the respective visualisation or content. It will also be appreciated that the interface will typically include options to allow searching, for example to allow different categories to be viewed and/or to allow different visualisations to be viewed.

Accordingly, in one example, the present invention seeks to provide an augmented reality marketplace, allowing augmented reality content to be created, bought, sold, shared, or otherwise made available, so that this can be associated with patterned objects, thereby allowing this to be viewed upon imaging of the object using a suitable client device.

At step 555, the user selects a visualisation, with the client device 203 providing an indication of the selected visualisation to the server 210, allowing the server to debit the user account at step 560 and add the visualisation to the user's profile at step 565. At this point, the visualisation could be automatically associated with the pattern identifier determined at steps 515 to 525 above. Alternatively, the user could select to scan the pattern provided on a different object, and associate the visualisation with a different identifier.

It will be appreciated that in a similar manner, the user can also acquire content, which is then associated with the object. The content could be multimedia content, such as a video, music, animation, or the like, which is then uploaded to the client device 203 and displayed to the user when the object is imaged and a visualisation is displayed to the user. Thus, it will be appreciated from this that the visualisation could include the multimedia, which is presented to the user as the visualisation.

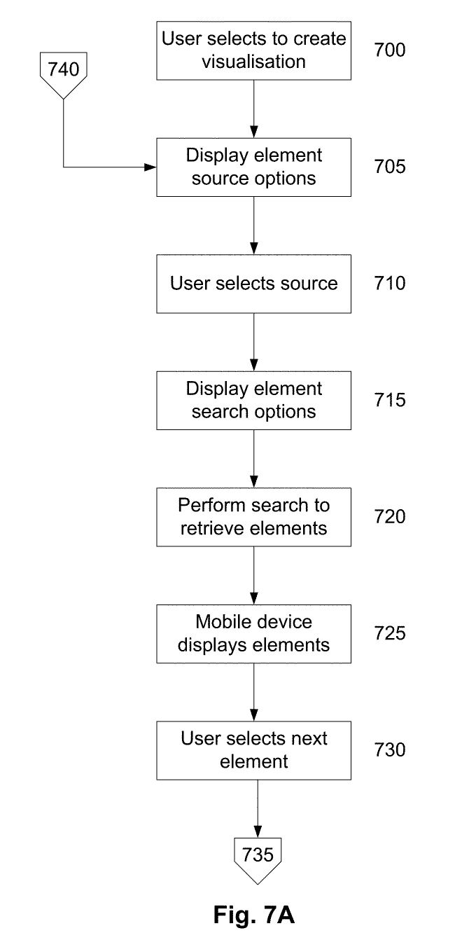

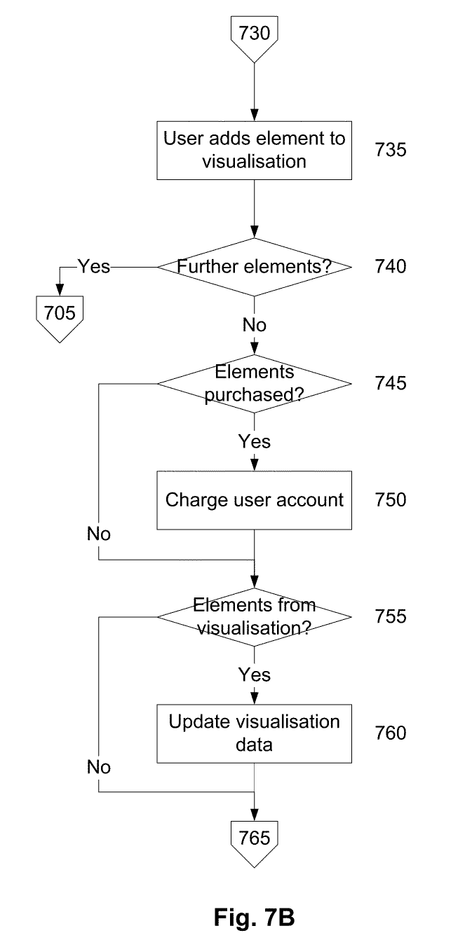

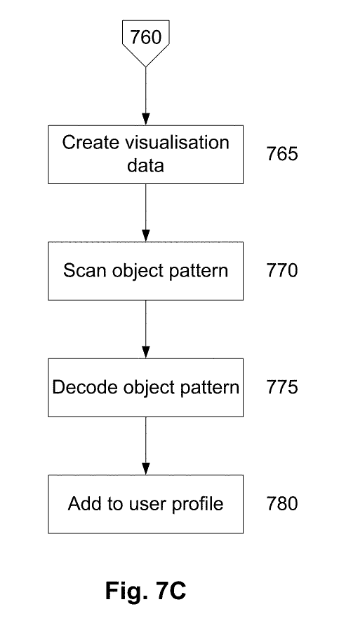

An example of the process for creating a visualisation will now be described with reference to FIGS. 7A to 7C.

In this example, the creation of a visualisation is performed using the app installed on the client device 203. In this regard, the app will typically display a number of options regarding actions the user can perform, such as allowing the user to create and update profiles, browse existing visualisations or the like. In this instance, the user selects a “create visualisation” option at step 700.

At step 705 the client device operates to display element source options to the user. In particular, this corresponds to sources from which the user can obtain visualisation elements. This could include, for example, retrieving locally stored files, such as multimedia files that can act as visualisation elements, obtaining visualisation elements from existing visualisation data either within the user's profile or received from other users, or selecting to retrieve visualisation elements from a store or marketplace. For example, this could include pictures or images, such as self-created avatars, a scan or image of the user, a friend of the user, or other image of picture.

Once the user has selected a source, the client device 203 could simply list or display appropriate visualisation elements, but more typically will display search options, allowing the user to perform a search and identify visualisation elements of interest. Thus, at step 720 the user provides various search parameters, for example specifying attributes of the visualisation elements, such a type, category, name keyword, theme, or the like. The client device 203 then causes a search of the relevant source to be performed at step 720, receiving and displaying an indication of available visualisation elements at step 725. Additionally, and/or alternatively, the user may simply be presented with a list of available elements, allowing the user to scroll through and view these as desired. Other input mechanisms could also be used, such as shaking the phone to randomise the elements displayed. Users could also use unlock codes, or the like, allowing specific elements to be unlocked, for example in reward for completing a task.

In one example, the visualisation elements can be purchased from a hosted store, in which case details of the visualisation elements are retrieved from a server 210. This would typically include having the server 210 provide a visual representation of the visualisation element, and optionally a description of the element, together with other required information, such as a cost associated with the element, or the like.

In any event, it will be appreciated that visualisation elements can be retrieved using any standard searching process, and could involve providing access to files, allowing these to be browsed, displaying list of categories of visualisation elements, allowing users to progressively refine the search, until visualisation elements of interest are identified.

Alternatively, the user could opt to create a visualisation element using an external software package, such as by taking or modifying a photo, using a drawing package, or the like, and then importing this into the app. For example, the user could create their own visualisation elements by importing photos/or video and wrapping this around a 3D polygon base. The user could be presented with a text template, and then enter text allowing text messages or similar to be created. The user could also import virtual goods or rewards from other software into the app, allowing the user to display an indication of their affiliation with another game or the like, for example by showing rewards earned within that game.

In any event, having identified visualisation elements of interest, a user then selects a next one of the elements at step 730, and then adds the element to the visualisation at step 735. This could be achieved in any suitable manner, such as by dragging and dropping the visualisation element into a graphical representation of the visualisation, or using other input commands, such swiping the screen, or using a defined sequence of movements of the client device, with this being detected by the client device 203 and used to interpret the action so as to add the visualisation element to the visualisation.

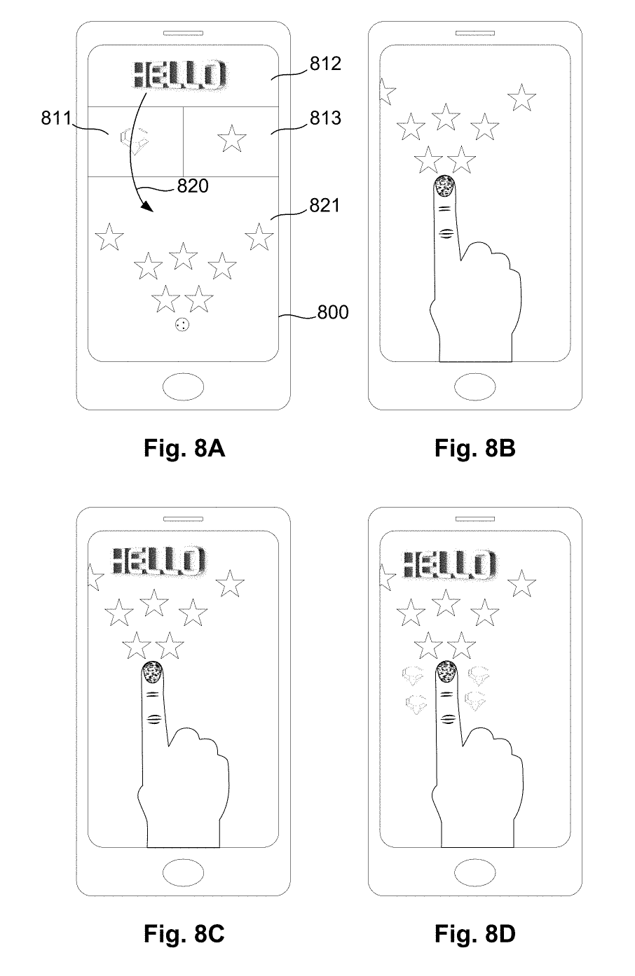

An example of this is shown in FIG. 8A in which a user interface 800 is provided on the client device 203, including visualisation elements 811, 812, 813 and a visualisation representation 821 which shows elements currently forming part of the representation. In this instance, the user can drag the “Hello” visualisation element 812 and add this to the existing representation 813, as shown by the arrow 820.

At step 740, it is determined further elements are required and if so the process can return to step 705 allowing additional searching to be performed. It will be appreciated that this process can be repeated allowing visualisations to be gradually built up by adding successive visualisation elements as shown in FIGS. 8B to 8D.

Similar processes could be used to add a wide range of visualisation elements to the visualisation, and the above examples are not intended to be limiting. For example, if a user wishes to add wording, they could select and position a text element within the visualisation, and then type in the wording to be displayed. Similarly, with actions, the user could select an existing visualisation element within the visualisation, and then select one of a number of defined actions to be associated with the selected element. This could include modifying the appearance of the element, for example to cause the element to rotate or change colour, or an action such as launching another application, or the like.

Once it is determined that all required elements are added, the client device determines whether any of the elements have been purchased at step 745, for example if these were retrieved from the store as described above. If this is the case, the user account can be charged at step 750, for example by having the client device confirm to the server 210 which visualisation elements are included in the final visualisation. Alternatively, the information displayed by the app could be hosted by the server 210, allowing the server 210 to automatically determine acquired elements and charge the user account accordingly.

At step 755, it is determined if elements are used from other visualisations. If so, visualisation data of the other visualisations can be updated, for example to remove those visualisation elements therefrom, at step 760. This is used to allow users to extract visualisation elements from visualisations, but avoid them simply copying the elements, thereby circumventing the need to pay to acquire new visualisation elements.

Following this at step 765 the visualisation data is created. The visualisation data specifies how the visualisation should be presented and typically includes at least an indication of the visualisation elements, and optionally their position within the representation, as well any other information, such as action associated with the visualisation. The visualisation data can be generated by the client device 203 and or the server 210, depending on the preferred implementation.

Following this the user could elect to simply store the visualisation data within their user profile for later use, but more typically would proceed with scanning an object at step 770. The scanned pattern is decoded either by the client device 203 or the server 210, at step 775, with the visualisation data and identifier being associated with each other and added to the user profile at step 780, to thereby assign the visualisation to the respective pattern. This association can then be subsequently used to identify the relevant visualisation when the respective pattern is next scanned, allowing the relevant visualisation to be displayed.

In addition to simply displaying visualisations a number of different processes can be performed, which enhance the interactive nature of the system. Examples of these include the ability to gift, exchange or sell visualisations, create and publish images including visualisations and view third party visualisations. Examples of these will now be described in more detail.

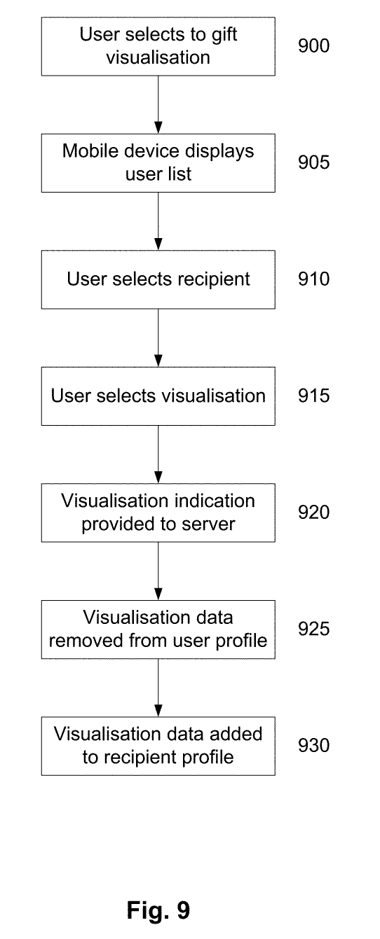

An example of a process for gifting a visualisation will now be described with reference to FIG. 9.

In this example, at step 900 the user selects a “gift visualisation” option displayed by the app on the client device 203. The client device 203 then displays a user list of other users to which the user can gift the visualisation. The user lists could be a list of the current user's “friends” or alternatively could be a user list of any user associated with the scheme. It will be appreciated as part of this process searching to identify one or more particular users may be performed, and that user details could be stored either locally on the client device 203, for example as part of a contact list within the app, or could be retrieved from the server 210, allowing the user to select a recipient at step 910.

Following this, the user selects a visualisation to gift step 915. This can be achieved in any suitable manner, and could involve having the client device 203 display a list of visualisations to the user, for example based on the visualisations stored within the user's profile, allowing the user to search through the visualisations and select a visualisation to gift.

At step 920 the client device 203 determines the visualisation selected by the user and provides an indication of the selected visualisation to the server 210. At step 925, the server 210 removes the visualisation data from the current user's profile, and adds the visualisation data to the user profile of the recipient user at step 930. When the recipient next accesses their user profile the visualisation will then be available to them, allowing them to associate this with one of their own patterns and hence view the visualisation.

Whilst the above described example involves gifting the visualisation so that this is no longer owned by the original user, it will be appreciated that a similar mechanism could be used to share visualisations. In this regard, visualisations could be shared on a limited basis, for example by allowing any one user to share a visualisation they have purchased a set number of times, or alternatively could be for a limited period of time, for example allowing the friend to use the visualisation for one day, after which time they may purchase their own copy. These techniques can be used to monetise the visualisations, creating an inherent value within the visualisations.

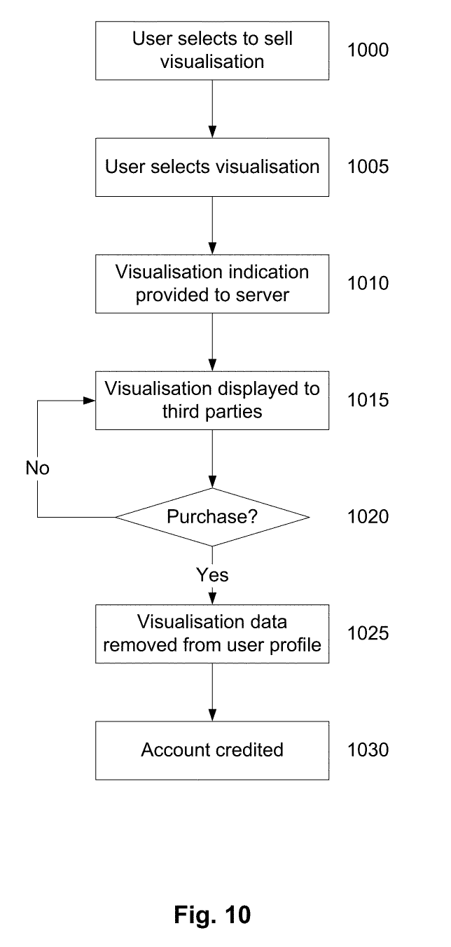

As an alternative, users are able to monetise visualisations they have created by selling visualisations, and an example of this process will now be described with reference to FIG. 10.

In this example, at step 1000 the user selects to sell a visualisation, again by selecting an appropriate option presented via the app user interface on the client device 203. The user then selects a visualisation at step 1005 with an indication of the selected visualisation being provided to the server at step 1010. It will be appreciated that these steps are generally similar to steps 915 and 920 described above and these will not therefore be described in detail.

At step 1015 the visualisation is then displayed to third parties through a visualisation store. The visualisation store allows individuals to browse visualisations that can be purchased, allowing the user to acquire these and then add them to their user profile, selecting any of these that are of interest to them. In the event that the visualisation is not purchased it simply remains in the store. However, once purchased, the visualisation data is then removed from the user profile of the individual who created the visualisation, with their account being credited at step 1030.

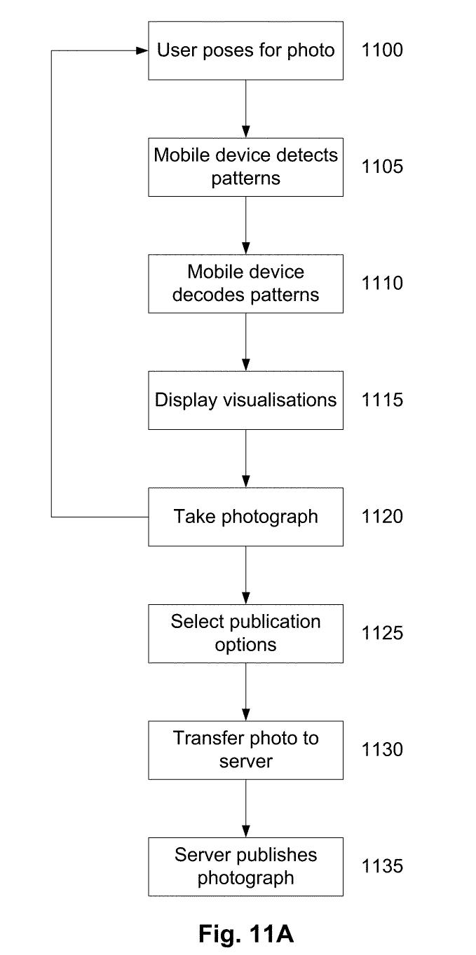

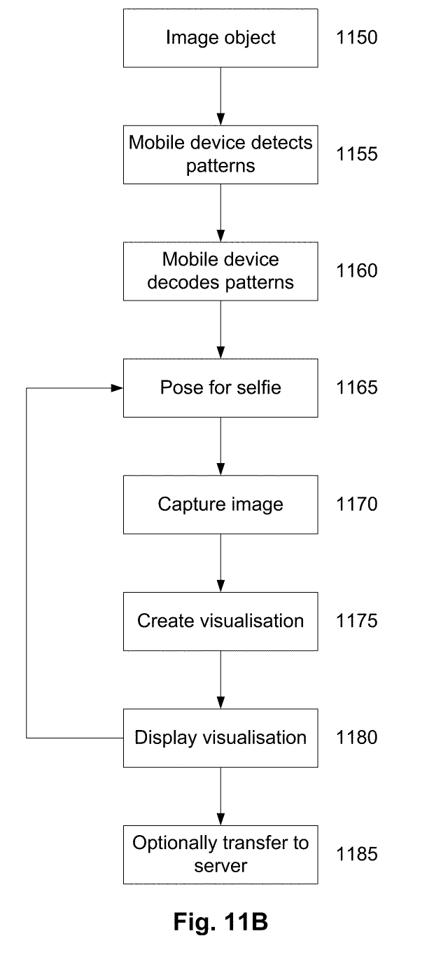

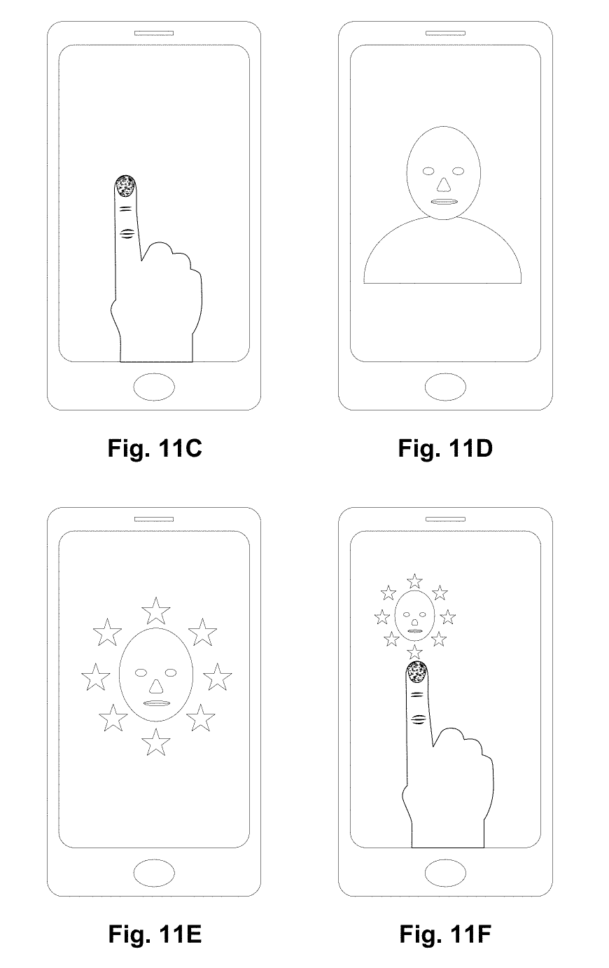

An example of the process for publishing a photo including visualisations will now be described with reference to FIG. 11A.

In this example, at step 1100 a user poses for a “selfie” photo, using the imaging device 404 provided on their client device 203. At step 1105, the client device 203 detects patterns on objects worn by the user, decoding the patterns at step 1110, and then displaying the respective visualisations at step 1115, using a process substantially to that described above.

Once the user is happy with the image as framed, the photograph can be captured at step 1120 by selecting an appropriate option displayed on the app. The photograph includes an image of the wearer, as well as the visualisations associated with the objects worn by the user. At this point, the photograph is typically displayed to the user allowing them to select to take further actions, such as to publish, save or delete the photograph. It will be appreciated that this process can be repeated until the user has a photograph with which they are satisfied.

In the event that the user selects a publish photo or video option presented via the app on the client device 203, at step 1125 publication options can be displayed to the user allowing them to select how to publish the photo. Publication options could be used to select whether the publication should be to specified recipients, or more general widespread publication. The publication options could also specify whether to publish the photo to other social media networks such as Twitter™, Facebook™, WeChat™, Snapchat™, Weibo™ or the like.

The photo is then transferred to the server 210 at step 1130, together with an indication of the publication options, allowing the server 210 to publish the photo at step 1135 in accordance with the publication options.

An example of the process for generating a visualisation will now be described with reference to FIGS. 11B to 11F.

In this example, at step 1150 a user uses the imaging device 404 provided on their client device 203 to image objects, as shown in FIG. 11C, thereby detecting patterns on the objects at step 1155, decoding the patterns at step 1160 to determine a visualisation. In this regard, if this is the first time the object has been scanned, or if the user has selected to create a new “selfie” visualisation, at step 1165, the user is prompted to pose for a “selfie” photo, as shown in FIG. 11D. The client device 203 uses the imaging device to capture an image, and detect the face of the user at step 1170, as shown in FIG. 11E. The user's face is then combined with a default visualisation, for example to frame the user's face with stars or other visualisation elements at step 1175, so that the next time the user scans the patterns on the objects, the visualisation including the user's face is displayed as shown in FIG. 11F, at step 1180.

It will be appreciated that this process can be repeated until the user is happy with the image at which point, the user can select further options, such as to publish the visualisation, in which case the visualisation can be transferred to the server 210 at step 1185, allowing this to be published, shared, or made available via the store. This also allows the visualisation to be used in other manners, for example allowing this to be on patterns, fashions, accessories or the like.

Whilst the above described process is performed in respect of an image, it will be appreciated that a similar technique could also be applied to a video, image sequence, captured gif, 3D animation, captured audio information, or the like.

Throughout the above described processes, the user's client device is typically used to image objects worn by the user themselves, so the client device 203 will automatically access the user profile associated with the owner of the client device, either locally or from the server 210. However, this is not essential and the client device could also be used to image other users, in which case the client device 203 can be used to access the user profile of the individual that is being imaged, thereby allowing the imaged user's visualisations to be displayed.

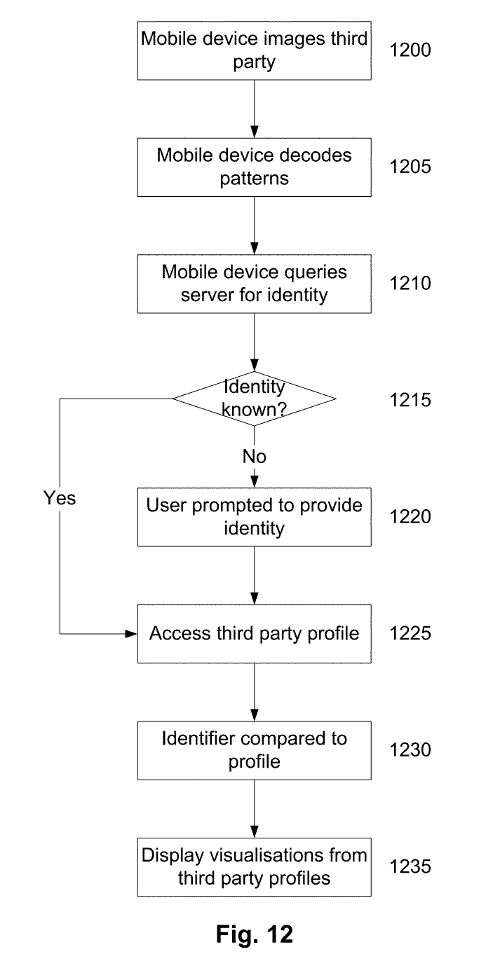

An example of this will now be described with reference to FIG. 12.

In this example, at step 1200 the user uses their client device 203 to image a third party and decodes patterns associated with objects worn by the third party at step 1205, thereby determining pattern identifiers, in a manner similar to that described above.

The mobile device then queries the server 210 for an identity of the third party at step 1210. At step 1215 the server determines if the user's identity is known.

This could be achieved by detecting an identifier that is associated with a pattern unique to that individual. In this regard, particular users may be able to acquire their own patterns so that those individuals can be uniquely identified by way of their pattern, and the unique identifier associated with the pattern. Alternatively, users may use a particular combination of patterns in order to identify themselves, for example by having a set predefined sequence or combination of patterns associated with one or more objects. As a further alternative, if the captured image includes biometric information, such as image of a third party's face, this can also be used in order to identify the third party, for example using facial recognition techniques.

If not the third party's identity is not known, then at step 1220 the user is prompted to provide the identity, for example by selecting the third party from a list of other users, either from a local contact list or from a list of user hosted by the server 210.

In any event, once the third party's identity is known this can be used to access the third party's user profile at step 1225, retrieve visualisation data associated with the pattern identifiers at step 1230, and then display visualisations from the third party's profile at step 1235.

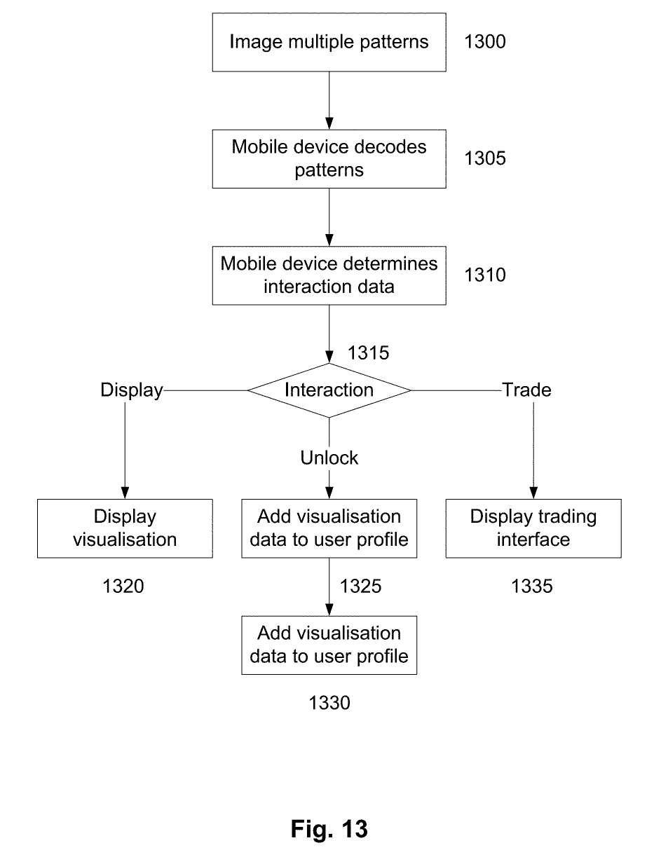

The above described example has focussed on displaying a single visualisation associated with a single pattern. However, it will be appreciated that multiple patterns could be scanned simultaneously in a single operation, in which case a number of different interactions can be performed, such as displaying the visualisations associated with each of the patterns will be displayed simultaneously. unlocking additional visualisations, or other rewards, or the like. An example of this will now be described with respect to FIG. 13.

In this example, at step 1300 multiple patterns are scanned by a client device. For example, a number of users could each hold their objects in a field of view of a single client device. At step 1305, the client device then decodes the patterns to determine pattern identifiers using the techniques previously described.

In this example, at step 1310 the multiple pattern identifiers are used to determine interaction data. Whilst this could be defined within the user profile, more typically this is stored separately by the server 204, for example as an interaction profile, defining one or more interactions associated with different combinations of patterns, in which case the client device provides the decoded pattern identifiers to the server 204 causing the server to return an indication of the interaction data, including any other required information, such as visualisation data.

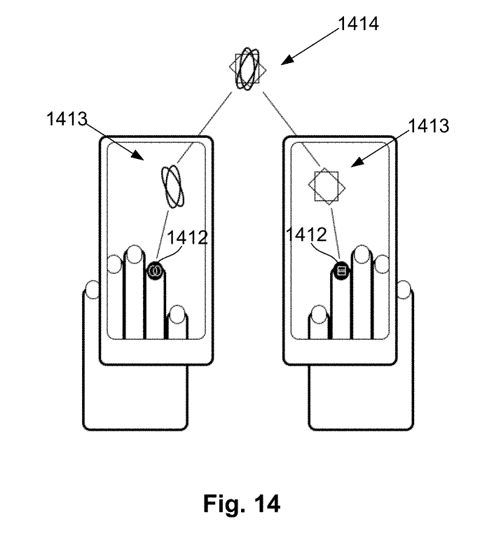

At step 1315, the client device determines the interaction type and performs the appropriate interaction. For example, if the interaction is to display a visualisation, then at step 1320 the visualisation is displayed by the client device 203. The visualisation could be a composite visualisation based on a superposition of the individual visualisations, and an example of this is shown in FIG. 14. In this example, two separate visualisations 1413 are displayed based on respective patterns 1412. In this instance, if scanned together, this results in the composite visualisation 1414 being displayed. Thus, this allows each pattern to be detected and decoded using the techniques outlined above, with each of the visualisations then being displayed on the client device in a defined relative position with respect to each respective pattern.

However, this could also be used to provide access to a new representation. In this regard, scanning of multiple patterns can be used to unlock further visualisations, for example, as opposed to showing a simple collocation of individual visualisations, this could be used to cause an entirely new visualisation to be accessed and displayed. In this case, at step 1325 the new visualisation is unlocked by adding visualisation data to the user profile, and allowing the visualisation to be then used, for example by displaying the visualisation at step 1330.

By way of an example, if a number of users each own one of a set of patterns, if all the patterns within the set are scanned simultaneously by a client device, this could allow a new default visualisation to be unlocked and added to the user profile of the user of the client device.

In a further variation, at step 1335, the user could be presented with a trading screen, allowing them to trade a representation, such as the unlocked or composite representation.

It will also be appreciated that whilst the above example has focused on scanning multiple patterns using a single client device, this is not essential, and similar techniques could be implemented for multiple client devices that are associated in some way. This could be achieved in a number of ways, such as based on a friend relationship status of respective users. In this example, if a number of friends scan patterns substantially simultaneously using respective client devices, the decoded patterns could be consolidated by the server, allowing the same process as described above to be performed. The association could also be determined in other ways, such as if the client devices are in a single location, as determined from GPS or the like, or if the client devices are synchronised by Bluetooth, or the like.

Accordingly, the above described system provides mechanisms for allowing augmented reality visualisations to be created and associated with objects displaying specific patterns. The visualisations typically include a number of visualisation elements, providing a mechanism to allow elements from different visualisations to be combined and interchanged, thereby allowing new visualisations to be created and shared. This allows users to define their own virtual appearance, and then share this, for example by publishing photos, videos, animations, or the like. User profiles defining associations between respective patterns and in particular visualisations can be hosted by the server 210, allowing third parties to access to a user's profile, allowing the third parties to view a user's virtual appearance.

Additionally, actions can be associated with patterns and/or visualisations. This can be used to enable the objects to be used as input devices, for example to control games. Thus the user could be required to present a particular pattern to their client device in order to allow a certain action within a game to be performed, or to allow the client device to be controlled in a certain manner, for example to open an application, generate haptic feedback or the like. Thus, the user could define to associate a particular pattern with a particular application, such as a social media feed or messaging application, causing that application to be opened when they scan the respective pattern.

This also allows visualisations to be provided that are interactive, for example allowing the appearance of the visualisation to be modified dynamically, for example based on user inputs. This could include moving or animating the visualisation, for example allowing the user to view a hologrammatic visualisation from different angles, to trigger an animation, playback of a video or the like.

In one example, this allows the visualisation to represent a user interface for a game. In this instance, the user displays the game by scanning a respective object pattern, and then can interact with the game using a variety of input techniques. This could include using an input of the client device, such as the touch screen, or microphone in the case of voice command inputs, allowing the user to play the game. Alternatively, interaction could by way of scanning other patterns, allowing actions within the game to be performed.

In one example, interaction is achieved based on relative movement of the object and the imaging device of the client device. For example, a character can be associated with the object, so that the character is displayed at a fixed location relative to the object. The user is then able to navigate with respect to other game characters or a gaming environment that are displayed via the client device. Thus, in this example, the relative position of the object in the field of view of the imaging device is used to act as input controls for the game, controlling the position of the character within the game.

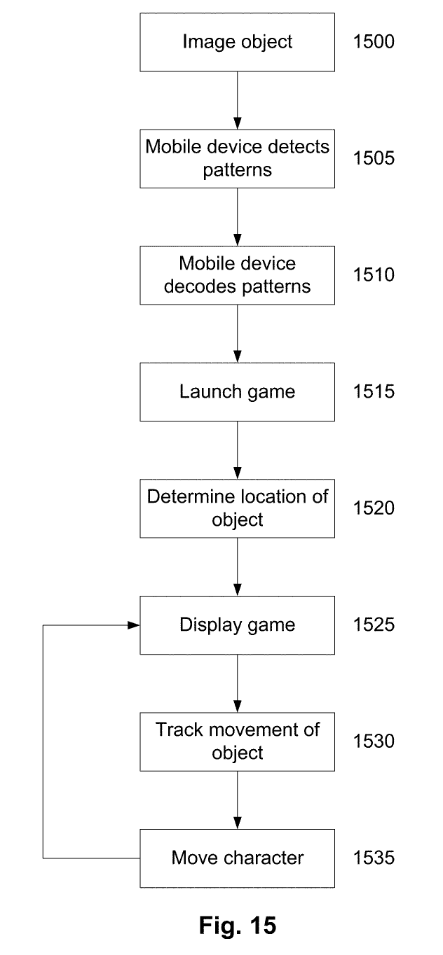

An example of this process will now be described with reference to FIG. 15.

In this example, at step 1500 a user uses the imaging device 404 provided on their client device 203 to image an object, thereby detecting patterns on the object at step 1505. Upon decoding the patterns at step 1510, the client device 203 can determine that the visualisation corresponds to a gaming character, and launches a game, displaying a gaming environment on the client device display 403 at step 1515. The client device 203 determines the location of the object within the imaging device field of view at step 1520, and displays a gaming character in the gaming environment at a corresponding location in the gaming environment at step 1525. The client device 203 can then track relative movement of the object within the field of view of the imaging device at step 1530, and cause corresponding movement of the character within the gaming environment at step 1535, thereby progressing the game.

In another example, the game can include a virtual pet, the user can scan a particular pattern to cause the pet and a pet status to be displayed. The user can then interact with the pet, for example to feed the pet, by scanning a different pattern corresponding to a feeding action, or the like.

Similarly visualisations could be adapted to interact in other manners. For example, the visualisations could correspond to characters, such as Pokemon or the like, which are able to fight. In this instance, when the patterns associated with two such characters are scanned simultaneously, or sequentially within a defined time limit, they will interact, with the user profile being updated based on the outcome of the interaction.

From this, it will be appreciated that visualisations can be adapted to change dynamically over time, for example by allowing the visualisations to develop as further user interaction is performed. This can be used to unlock rewards, for example if certain tasks or goals are completed, which in turn encourages user interaction with, and hence popularity of the system.

Furthermore, by hosting user profiles centrally, this allows additional control to be provided over patterns. For example, patterns can be adapted to expire, so that they only have a defined lifespan within the ecosystem. To achieve this, after a defined time limit, associations within the user profiles can be deleted, thereby precluding the associations being used to display a visualisation. This can be used to discourage counterfeiting of products, for example, by ensuring that patterns expire before counterfeiters are able to widely use the patterns, as well as allowing fashion companies to ensure their products are regularly updated.

Patterns can be custom designed, for example, for a particular company or product, in which case the patterns may be locked so that only default defined patterns are associated with the pattern. For example, a company could provide visualisations in the form of logos, or the like, so that when a user views a pattern provided on the product, the brand owner's logo is displayed.

The patterns are typically applied to the objects during manufacture, and this could be achieved by printing the pattern on the object, although applying a label or other mechanism could also be used. In any event, to ensure the pattern has been suitably applied, it is typical to test detection of the pattern prior to making the object available.

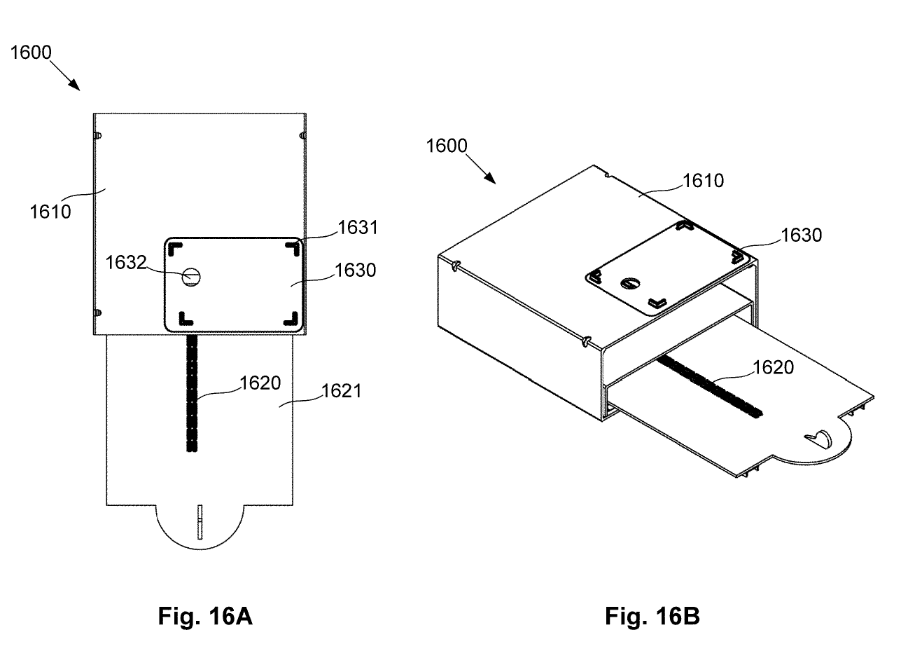

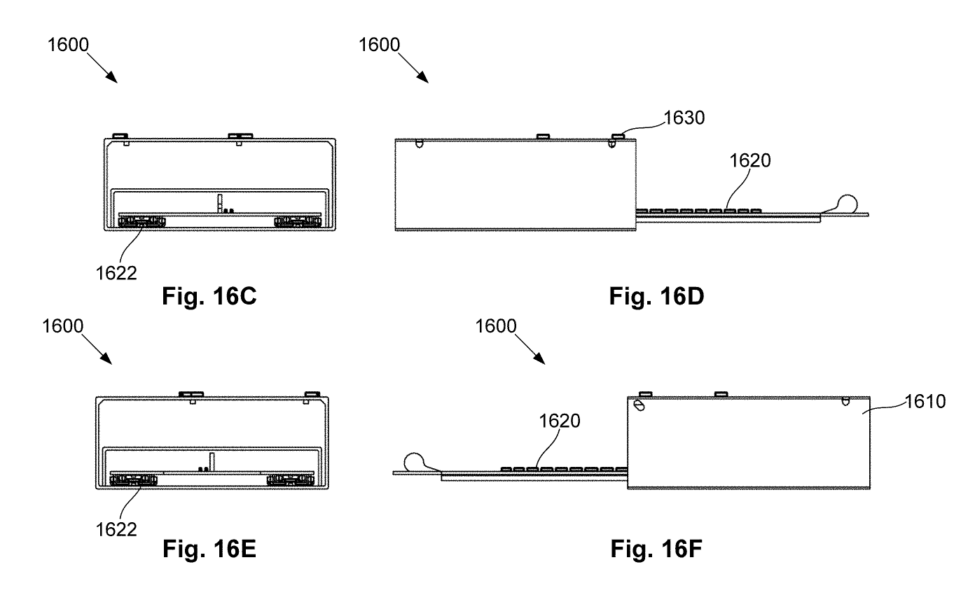

Accordingly, in another example, a testing system can be provided for testing production of an augmented reality object, and an example of this will now be described with reference to FIGS. 16A to 16F.

In this example, the testing system 1600 includes a housing 1610 and a stand 1620 that supports a plurality of objects within the housing 1610. The stand is typically removable, allowing the objects to be mounted on the stand before the stand is positioned within the housing.

The housing includes an illumination source (not shown) for illuminating the plurality of objects provided on the stand 1620. The illumination source can be of any appropriate form, but is intended to mimic typical usage settings for the objects. A mounting 1630 is coupled to the housing that in use receives a client device, allowing the client device to be used to image the objects.

In use, objects are positioned on the stand 1620, which is then positioned within the housing 1610. A testing app operating on a testing client device, mounted to the housing, is then used to image the objects, identify the patterns on the objects using signals from the imaging device, determine an identifier associated with the pattern and validate the identifier.

Accordingly, this provides controlled conditions that can be used to ensure that the patterns have been appropriately provided on the objects and in particular that they can be detected and decoded, allowing the pattern identifiers to be accurately determined.

A number of further features will now be described.

In one example, the mounting 1630 includes bosses 1631 that position an imaging device of the client device in a defined position relative to the housing, which in one example is performed so that an imaging device 404 of the client device 203 is aligned with an aperture 1632 in the housing 1630.

The mounting 1630 is removably replaceable allowing the mounting 1630 to be detached from the housing 1610 and replaced, so that a respective mounting can be provided for each of a number of different client devices, for example to allow different models of client device to be used in the testing process.

The stand 1620 is provided proud of a stand surface 1621 that has a mid-tone contrast, and in particular a middle grey or more specifically pantone 425U colour. This is performed to simulate the contrast between the object and skin tones in use. The stand and stand surface are typically supported on sliding rails 1622, allowing the stand to be slid into and out of the housing, thereby allowing the objects to be provided on the stand.

The illumination source includes a plurality of LEDs configured to provide about 800 lux illumination to thereby simulate typical lighting conditions.

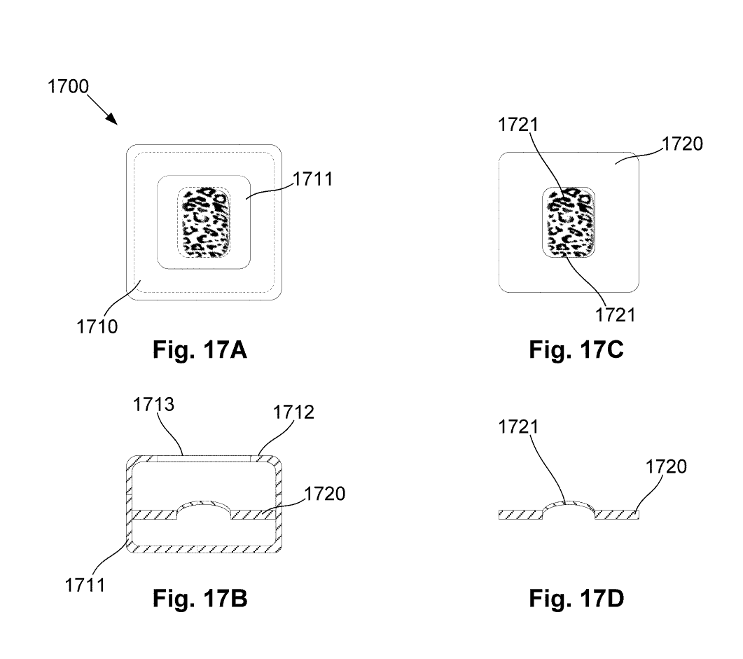

Additionally, in one example, packaging for an augmented reality object can be provided and a first example of this will now be described with reference to FIGS. 17A to 17D.

The packaging 1700 includes a housing 1710, which in this example is a generally cuboid body having a base 1711 and a lid 1712, although other suitable configurations could be used.

The housing 1710 includes a window 1713 provided by a substantially transparent portion of the housing, which in this example is formed within the lid 1712. A mounting 1720 is provided within the housing 1710, including at least one opening 1721 that supports a nail 1722 therein. The mounting 1720 is positioned within the housing 1710 so that a patterned surface of the nail is aligned with the window 1711, thereby allowing the pattern to be imaged by an imaging device whilst the nail is within the packaging.

In the current example, the mounting 1710 is in the form of a laminar card, with the opening being formed by a cut-out section of the card, and the card being over-sized to thereby engage inner surfaces of the housing 1710, thereby holding the card in position through frictional engagement. However, this is not essential, and any suitable arrangement could be used.

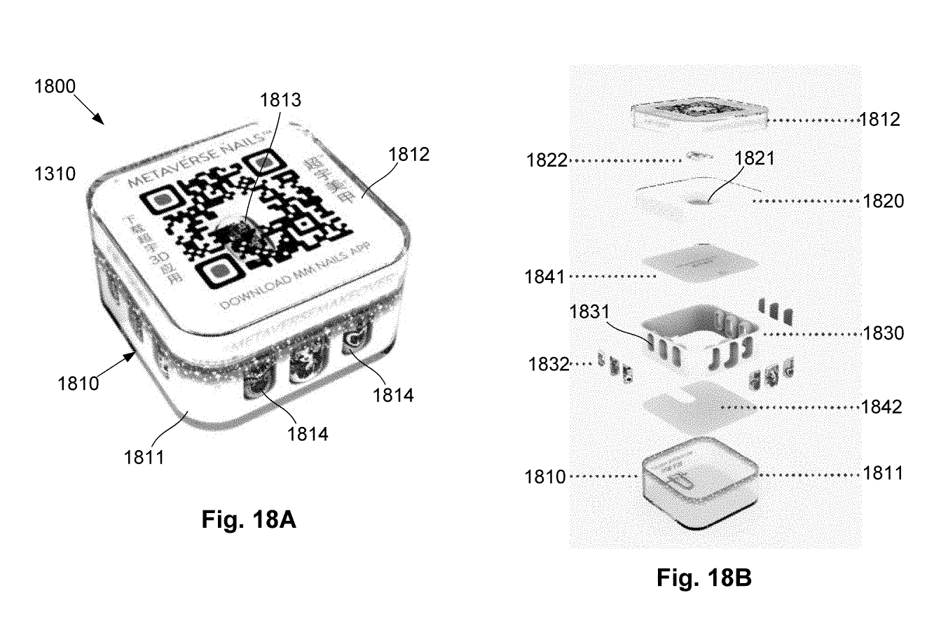

The example of FIGS. 17A to 17D is intended for use with a single nail. Alternatively the packaging can be used to display multiple products, and an example of this is shown in FIGS. 18A and 18B.

The packaging 1800 includes a housing 1810, which in this example is a generally cuboid body having a base 1811 and a lid 1812, although again other configurations, such as cylindrical bodies, or the like could be used.

Again, a window 1813 is positioned in a front surface of the housing 1810, with a front surface mounting 1820 including a single opening 1821 aligned with the front surface window that supports a nail 1822 therein.

Additionally, the housing 1810 includes a plurality of windows 1816 spaced around an outer perimeter edge surface, and wherein the mounting is an edge surface mounting 1830 including plurality of openings 1831, in the form of respective recesses, each opening being aligned with a respective window. In this example, the windows are formed from a continuous transparent edge surface of the body, and are therefore at least partially defined by the edge surface mounting 1830.

In use the packaging can contain instructions cards 1841, 1842, providing instructions for use, as well as machine readable codes that can be used to allow the app to be downloaded to a client device.

In any event, it will be appreciated that a number of false nails can be displayed in a manner which allows each of these to be individually scanned using a client device, thereby allowing associated visualisations to be displayed.

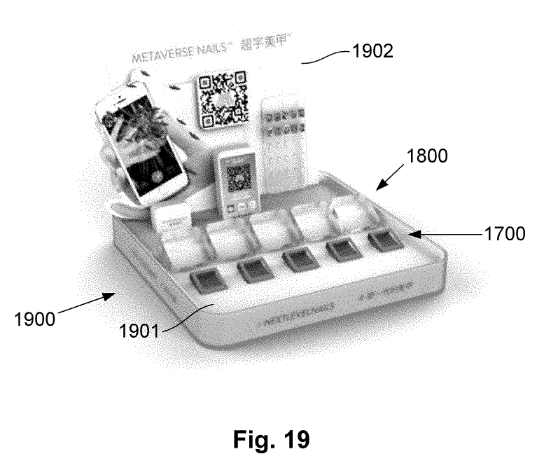

A stand for displaying the display packing 1700, 1800 is shown in FIG. 19.

In this example, the stand includes 1900 includes a base 1901 having a number of recesses for receiving packaging 1700, 1800, and a display card 1902 projecting upwardly from the base 1061 to display information regarding the product.

The above described augmented reality system can be used for a wide variety of uses. Some examples will now be described although it will be appreciated that these are not intended to be limiting.

The system can be used to provide personal messaging for example by defining visualisations including messages such as personalised holograms. In this example, typing in an emoji, sticker or textural message on the mobile client device keyboard can be used to generate a 3D hologram visualisation that includes the message text. This can then be assigned to a respective pattern, with this association being shared with other users, allowing the other users to view the message when scanning the respective pattern. This provides a mechanism to share information with other users.

Images, photos and messages can also be shared in a similar manner by associating these with a respective pattern within other user's profiles. In this example, the message or shared image, photo or the like can then be displayed by having the other users scan their own wearable objects.

Particular combinations of patterns or visualisations can be used for gaming or other interactive features, for example by having various input commands or actions assigned to particular sequences of pattern. In this example, by having a user image the patterns in a defined sequence, a particular interactive game feature or other input command is implemented, allowing users to use the wearable objects to interact with games.

Gaming features can also include using the visualisations as a gaming interface, for example displaying a character, such as a virtual avatar or the like, with which users can interact, either through the use of various input commands, or by scanning respective patterns. This can be used to allowing the patterns to be used to host Tamagotchi-style virtual pets that can be cared for, encouraging individuals to interact further with wearable patterns.

It will be appreciated that in one example, access to games or applications could therefore be provided by providing a pattern in which the game is the default visualisations associated with the pattern. Thus, a game supplier could sell patterned objects as a mechanism for allowing users to access the game, with the game being accessed by scanning the product as described above. In one example, the pattern could be associated with a gaming character, so that for example, scanning a badge displaying the gaming character could be used to display the game visualisation.

It will be appreciated from this that this makes the above described system attractive as a platform allowing media and gaming suppliers to distribute content and games. Accordingly, it will be appreciated that the platform could be licensed to a number of different providers allowing providers to provide respective interactive market places.

Suppliers of products or services, particularly in the fashion industry, can generate bespoke patterns, which could be applied to apparel such as fabrics, tights, garments, clothing, logos or the like, which can then be used to interact with the augmented reality system. The patterns could be new custom patterns, or could correspond to existing logos, or the like, allowing the supplier to encourage user interaction with their logo or brand. In this example, when respective patterns are scanned this can be used to display default visualisations corresponding to information regarding the products or the product supplier. Whilst this information could be static, more typically this is periodically updated, which allows product suppliers to encourage users to interact with their products, periodically changing the displayed visualisation so as to keep this fresh and encouraging further interaction. For example, the supplier could link a pattern to their Twitter™ or other social media feed, so that feed updates can be viewed by scanning the pattern.

Patterns can be applied to any suitable object in any manner and could for example be printed in layers or on surfaces, such as acrylic plastics, textiles, or the like. The patterns could be injected-moulded into plastic surfaces, applied via stickers or labels, or the like. It will also be appreciated that additional functionality can be implemented through the use of other sense able technologies, such as RFID, NFC chips or the like. For example, RFID tags can be inserted into patterned wearables and/or products, allowing for additional interaction to be performed. For example, this could be used to enable purchasing of AR content and virtual goods, and other mobile purchases from tapping the mobile screen or the like.

The above described system provides a marketplace that allows users to purchase entire visualisations, or virtual visualisation elements, which can then be combined to generate visualisations, with these then being associated with respective patterns to allow the visualisations to be displayed. The user profiles can be used to maintain relationships between visualisations and patterns, as well as allowing a user to view a purchase history to see what visualisations they have purchased or used.

Once visualisations have been created, the user is able to view these and optionally take photographs allowing the photos to be shared. These photos can be modified and then shared via social media in a suitable manner. This can be performed for example by associating a user account with a social media profile or the like.

Users are able to share and gift visualisations or visualisation elements by transferring these to other users, and also optionally sell the visualisations or visualisation elements through the marketplace acting as a shopping forum. Thus, visualisations can be published, traded, gifted, purchased or sold, allowing the marketplace to develop. Each visualisation can be treated as a physically distinct virtual object, by ensuring that this cannot be duplicated across multiple user profiles, leading to the creation of an inherent value associated with each visualisation.

It will also be appreciated that visualisations can be treated in a manner similar to trading cards, and each can be assigned a value allowing users to trade and share these. This can include placing an expiry time on the use of patterns or particular visualisations, or providing limited numbers so that these can have an increased value through rarity. This allows for the creation of rare visualisations, which may for example be discernible based on a unique pattern or packaging of an object, or could alternatively be allocated to users randomly when a new pattern is added to their profile, thereby encouraging user acquisition of patterns.

Users are able to interact with the system through any device capable of imaging and displaying information, including but not limited to augmented reality headsets, mobile client devices or the like. Additionally however the patterns can be used to interact with other devices which include an imaging ability, allowing the users to interact with computer systems or the like.

Throughout the above description, the focus has been on visualisations. In this regard, it will be understood that the term visualisation refers to any augmented reality content, and could include visual content, but could also be applied to other content that can be provided in an augmented reality form, such as audio content. The term visualisation should therefore be considered to encompass any augmented reality content, and whilst particularly focused on visual content, should not be considered so limiting.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1. A system for providing augmented reality, the system including a client device having:
a) an imaging device that in use images a pattern associated with at least part of an object;
b) a display; and
c) at least one electronic processing device that:
i) identifies the pattern using signals from the imaging device;
ii) identifies a visualisation associated with the pattern using a user profile defining visualisations associated with respective patterns, the visualisation being defined by visualisation data defining a combination of visualisation elements; and
iii) uses the visualisation data to causes the display to display:
(1) the object as imaged by the imaging device; and
(2) the visualisation provided in conjunction with the object.

2. (canceled)

3. A system according to claim 1, wherein a visualisation is defined by a user, and wherein the at least one processing device:
a) receives an indication of available visualisation elements from at least one of:
i) a remote server; and
ii) a client device associated with another user; and
b) displays a representation of a number of visualisation elements in response to the received indication;
c) determines selection of a combination of a plurality of visualisation elements in accordance with user input commands; and
d) uses the selected visualisation elements to create visualisation data defining the visualisation.

4. (canceled)

5. A system according to claim 3, wherein the at least one processing device:
a) displays a representation of the visualisation defined by the user; and
b) modifies the visualisation in accordance with user input commands.

6. (canceled)

7. A system according to claim 3, wherein the at least one processing device:
a) displays the representation of a number of visualisation elements using visualisation data indicative of a first visualisation; and
b) uses selection of at least one visualisation element to generate a second visualisation.

8. A system according to claim 1, wherein the visualisation elements include at least one of:
a) a visualisation position relative to the pattern;
b) multimedia content;
c) artist created content
d) a visualisation object;
e) a hologram;
f) an animation of a visualisation object;
g) visualisation text and
h) part of a gaming interface.

9. A system according to claim 1, wherein the at least one processing device:
a) determines an identity of another user; and
b) provides visualisation data to the other user, thereby allowing a user to share or gift a visualisation to the other user, by at least one of:
i) transferring the visualisation data to a client device of the other user; and
ii) storing the visualisation data as part of a user profile associated with the other user.

10. A system according to claim 1, wherein visualisation data for a number of visualisations is hosted by a remote server and wherein the at least one processing device retrieves the visualisation data from the remote server via a communications network.

11. A system according to claim 1, wherein a remote server hosts at least one of:
a) applications;
b) user profiles;
c) visualisations;
d) visualisation elements; and
e) content.

12. A system according to claim 11, wherein the at least one processing device:
a) determines a pattern identifier associated with the pattern;
b) provides the pattern identifier to the remote server via a communications network, the remote server being responsive to:
i) identify the visualisation associated with the pattern using the pattern identifier and the user profile; and
ii) provide an indication of the visualisation to the at least one processing device; and,
c) receives the indication of the visualisation from the remote server.

13. A system according to claim 11, wherein the at least one processing device:
a) provides pattern data indicative of the pattern to the remote server, the remote server being responsive to:
i) determines a pattern identifier associated with the pattern;
ii) identify the visualisation associated with the pattern using the pattern identifier and the user profile; and
iii) provide an indication of the visualisation to the at least one processing device; and,
b) receives the indication of the visualisation from the remote server.

14. A system according to claim 1, wherein a pattern identifier is used to identify a visualisation and wherein the pattern identifier is determined by at least one of:
a) performing matching of the pattern to one of a number of reference patterns using pattern matching; and,
b) decoding a pattern identifier encoded within the pattern using a decoding algorithm.

15. A system according to claim 1, wherein the object is an item of apparel, and wherein the at least one processing device:
a) determines a wearer identity associated with a wearer of the respective object using at least one of:
i) one or more patterns associated with objects worn by the user;
ii) facial recognition techniques; and
iii) user input commands; and
b) selects one of a number of user profiles using the wearer identity.

16. (canceled)

17. A system according to claim 1, wherein the system:
a) determines an action associated with a detected pattern, the action including at least one of:
i) unlocking rewards;
ii) unlocking additional features;
iii) unlocking additional visualisations;
iv) triggering interactions with the client device;
v) performing interactions with gaming;
vi) user input commands;
vii) deactivating an alarm;
viii) opening a message;
ix) opening an application;
x) purchasing content
xi) trading a visualisation; or
xii) providing access to additional content; and
b) causes the at least one action to be performed.

18. A system according to claim 1, wherein the system:
a) determines an action in accordance with at least one of:
i) user interaction with the visualisation;
ii) user input commands;
iii) relative movement of the client device and pattern;
iv) relative movement of the client device and one or more visualisation elements;
v) a location of the client device; and
b) causes at least one action to be performed.

19. A system according to claim 1, wherein the object is at least one of:
a) attachable fingernails;
b) toys;
c) packaging; and
d) clothing.

20. A method for providing augmented reality, the method including:
a) using an imaging device to image a pattern associated with at least part of an object;
b) in at least one electronic processing device:
i) identifying the pattern using signals from the imaging device;
ii) identifying a visualisation associated with the pattern using a user profile defining visualisations associated with respective patterns; and
iii) causing a display to display:
(1) the object as imaged by the imaging device; and
(2) the visualisation provided in conjunction with the object.

21-33. (canceled)

34. A system according to claim 1, wherein the system:
a) updates the user profile to record that a pattern has been scanned to maintain a scanning history for the user; and
b) determines if a task has been completed based on the scanning history for the user.

35. A system according to claim 1, wherein:
a) the imaging device is used to image multiple patterns;
b) the at least one electronic processing device, at least one of:
i) decodes the multiple patterns using signals from the imaging device;
ii) determines an interaction type associated with the multiple patterns, the interaction type including at least one of, displaying, unlocking and trading; and
iii) performs the interaction.

36. A system according to claim 1, wherein:
a) the imaging device is used to image multiple patterns;
b) the at least one electronic processing device, at least one of:
i) decodes the multiple patterns using signals from the imaging device;
ii) identifies a visualisation associated with each pattern; and
iii) causes the display to display a composite visualisation based on a superposition of the visualisations associated with each pattern.

37. A system according to claim 1, wherein the at least one electronic processing device presents a marketplace interface allowing the user to purchase, exchange or trade at least one of:
a) visualisations;
b) visualisation elements; and
c) content.

38. A system according to claim 37, wherein the interface includes:
a) a number of title bars, each title bar representing a different category;
b) a window associated with each title bar, with each window including icons representing available visualisations, visualisation elements or content.
